(19) United States
(12) Patent Application Publication
(10) Pub. No.: US 2023/0407157 A1
(43) Pub. Date: Dec. 21, 2023

(54) Wear-Resistant Compositions Including Crosslinked Aromatic Polymers and Methods for Improving Wear Resistance Using the Same

(71) Applicant: Greene, Tweed Technologies, Inc., Wilmington, DE (US)

(72) Inventors: Kerry A. Drake, Red Hill, PA (US); Le Song, Chalfont, PA (US); Mithun Bhattacharya, North Wales, PA (US); Daniel J. King, Quakertown, PA (US); Christopher Corrado, Hatfield, PA (US)

(21) Appl. No.: 18/164,485

(22) Filed: Feb. 3, 2023

Related U.S. Application Data
(60) Provisional application No. 63/306,257, filed on Feb. 3, 2022.

(51) Int. Cl. C09K 3/14

(52) U.S. Cl. CPC C09K 3/14

(57) ABSTRACT

Disclosed are compositions for use in forming articles subject to frictional force or for use in tribological systems and articles formed therefrom. Such compositions comprise at least one crosslinkable aromatic polymer matrix material which remains operable at a PV of at least about 75,000 psi-ft./min or more. Such at least one crosslinkable polymer may also be used as a filler in crosslinked form in a wear matrix material in further compositions herein, wherein a matrix material such as polytetrafluoroethylene, modified polytetrafluoroethylenes, and/or at least one aromatic polymer are filled with the crosslinked aromatic polymer filler to improve wear resistance of the composition. The wear resistance may be enhanced from about 200% to up to about 850% in comparison with known wear compositions or with respect to use of the same aromatic polymer filler that is not crosslinked. Methods of improving wear resistance, or the PV limit of wear compositions are also disclosed. Methods and compositions for substantially retaining dimensional stability and avoiding catastrophic failure about a critical transition temperature using the compositions herein are further disclosed.

### CROSS-REFERENCE TO RELATED APPLICATIONS

This non-provisional patent application claims the benefit under 35 U.S.C. § 119(e) to U.S. provisional patent application No. 63/306,257, filed Feb. 3, 2022, entitled “Wear-Resistant Compositions Including Crosslinked Aromatic Polymers and Methods for improving Wear Resistance Using the Same,” the entire disclosure of which is incorporated herein by reference.

### BACKGROUND OF THE INVENTION

### Field of the Invention

The invention is related to the field of wear-resistant materials for use in end applications in which frictional force is generated between moving parts and to the field of reducing wear due to frictional force in tribological systems.

### Description of Related Art

Many mechanical systems involve moving parts that interact for surface to surface contact or that contact materials that contact a surface causing frictional forces that create wear to moving parts and contact surfaces over time. For example, heavy machinery and material handling industries, such as those of the aerospace and energy industries, have a strong need for polymeric material that exhibits a high level of wear resistance, particularly at higher temperatures, and that can provide enhanced temperature durability.

Friction and wear are also major contributors to energy loss in moving parts such as gears, bearings, downhole tools, drills, pulleys, and also to surface damage in such parts and in various tools that routinely contact other surfaces in use.

Tribology is the study of frictional contact between surfaces. Energy loss and part wear and the need for replacement (as well as the weight and wear attributable to use of metals and hard ceramics in parts subject to surface to surface contact) inhibit the ability to make systems more efficient, to reduce the waste in manufacturing and to lower the energy requirements needed to manufacture goods. In the past tribology has been studied generally using metal to material or ceramic to material surface contact. Tribology of polymer to polymer surfaces is an increasingly important field, but is also much harder to predict and develop as factors that impact polymers are less of an issue when predicting behavior in metal and ceramic surface contact. For example, the coefficient of friction of a given metal surface is reasonably constant due to the strength and high heat resistance of most metals. When working with polymeric materials, their tribological properties are impacted to a greater degree depending on the polymer being used and the tribological conditions. The coefficient of friction of a given polymer can be impacted, in some cases, substantially, by the load applied, the sliding velocity, the temperature of the system and the polymer's critical transition temperatures, such as its glass transition temperature (T_{g}) and its melting temperature (Tₘ). At the critical transition temperature(s), wear properties can change due to softening or melting of the polymer matrix. For example, polyarylene polymers, such as polyetherether ketone (PEEK) polymers are specifically limited in utility when testing temperatures exceed critical wear temperatures, either because of the end application temperature employed or as a result of the application temperature in combination with temperature increases at the mating surface of a bearing or other component subject to friction due to frictional heating. See, A. Jean-Fulcrand et al., “Effect of Temperature on Tribological Performance of Polyetheretherketone-Polybenzimidazole Blend,” Tribology International 129 (2019) pp. 5-15.

As increasing loads and/or temperatures are applied, a given polymer may deform and its coefficient of friction may drop rapidly. Similarly, the sliding speed can generate heat and frictional energy that can negatively impact the coefficient of friction and wear properties. A polymer's coefficient of friction will also typically vary as it approaches and after it surpasses its critical transition temperature, T_{g} and/or Tₘ. There is a need in the art to develop polymeric tribological materials and systems that can provide adequate wear properties and that are stable in high pressure-velocity (“PV”) end applications so that they may be substituted for heavy metal parts, reduce wear and part replacement and make systems more efficient.

It has been shown in previous patents by the applicant herein that crosslinking aromatic polymers generally increases an aromatic polymer's mechanical properties and transition temperatures. In addition, if heavily crosslinked, components formed from such crosslinked polymers can be employed at temperatures that are above the melting point of the semicrystalline phase of the polymer system. Prior art application of compositions including an aromatic polymer and a crosslinking compound were developed by the applicant herein and have been employed to achieve materials with a high glass transition temperature compared to a non-cross-linked polymer as described in U.S. Pat. No. 9,006,353 B2. Such compositions are also described by the applicant in U.S. Pat. No. 9,109,080 in combination with a cross-linking additive to control the rate of crosslinking to enable melt processing of parts, such as by extrusion or injection molding, and/or to achieve improved mechanical properties at elevated temperatures for use in extrusion-resistant sealing components. See, U.S. Pat. Nos. 9,475,938 and 9,127,938.

Improvement of friction and wear-resistant properties, as well as enhanced temperature durability, especially in higher temperature, pressure and velocity end applications, will improve the sustainability and application temperature applicable for mobility and transport solutions. Products formed from wear resistant polymeric materials that can meet such conditions and provide improved wear properties for high PV applications include bearings, seals, fittings/connections, tools, moving parts, and engine parts used in industrial and commercial goods, including vehicles and appliance parts, and other goods and products with moving parts. Such materials can be substitutes for products that are typically made from other metal or ceramic wear substitutes such as engineering plastics or other enhanced plastics including fluoropolymers, e.g., high molecular weight polytetrafluoroethylene (PTFE) or modified PTFEs. While such materials have good wear properties, they are not mechanically strong and so must be filled or otherwise enhanced for wear applications. As matrix materials PTFE is not conventionally melt processable, and must be molded in a preform and sintered to form parts, such that such materials are hard to recycle and reuse once spent, and in some instances present environmental issues. Others, while stronger, exhibit variable or weak wear properties, particularly in high PV applications.

High performance polymers such as polyetherether ketone (PEEK), polyetherketone (PEK), polyetherketone ketone (PEKK), polyamideimide (PAI), polybutylene terephthalate (PBT), polybenzimidzole (PBI), polyphenylene sulfide (PPS), ultrahigh molecular weight polyethylene (UHMWPE), PTFE, polyoxyalkylenes such as polyoxymethylene (acetal), polyetherimides (PEI), polyamides (PA), polyimides (PI), fluoropolymers, including melt-processible fluoropolymers, such as copolymers of tetrafluoroethylene and perfluoroalkylvinyl ether, copolymers of tetrafluoroethylene and hexafluoropropylene, polychlorotrifluoroethylene (PCTFE) and polyvinylidene fluoride (PVDF) and other polymers including aromatic polyethers and polyketones are commonly used for friction resistant end applications. Such materials do have temperature limitations for the reasons noted above. Amorphous polymers, such as PEI and polyphenylsulfone (PPSU) and some grades of polyarylenes, such as PEKK, cannot be used above their glass transition temperatures (Tg) due to severe softening (approximately a 90% to 99% property drop) which can increase uncontrolled rubbing of surfaces in contact applications.

Semi-crystalline polymers can be used at temperatures above their Tg, but show a large drop-off in both surface and bulk properties at these temperatures due to the higher molecular mobility above Tg. This can cause catastrophic wear due to melting.

Often in such end applications, fluid exposures are also possible, such that the materials must also be chemically resistant. Thus, there are difficulties and limits in the use of such materials as wear matrix materials for tribological systems and in wear applications, particularly in high temperature and high PV applications.

As noted above, materials such as PTFE have been employed in friction end applications as PTFE matrix materials as it has excellent frictional properties, including a very low coefficient of friction. However, it lacks sufficient strength for many end applications and so performs poorly in more demanding applications such as high pressure-velocity applications (“PV applications”). To modify such properties, in a number of such applications, additives in the form of fillers or reinforcers are often provided to PTFE, such as PPS, PI, polyester, polysulfones (such as Ceramer® oxidized polyphenylsulfone) are added to PTFE, as well as carbon, coke and/or graphite, in levels of up to about 15% to increase the resistance to wear. PPS and PI are commonly used fillers; however, PPS has a Tg of about 90° C. (194° F.), which weakens the compound as it can lose 60-80% of its mechanical properties above its Tg. PI as a filler can sustain a higher temperature, but any exposure to water or water vapor can cause irreversible hydrolytic degradation which can weak the overall wear compound.

Thus, there is a need in the art to provide improved polymeric wear materials for use in applications subject to wear, especially in high temperature and/or high PV end applications, as matrix material and/or as fillers for existing wear compounds (such as those formed of PTFE) to increase the ability to employ such materials in tribological systems thereby increasing energy and cost efficiency, reducing weight and creating more sustainable industrial and commercial parts and products, more efficient manufacturing processes and increased recycling opportunities.

### BRIEF SUMMARY OF THE INVENTION

The invention herein addresses the deficiencies in the prior art by providing compositions and articles that enable polymeric materials to be used in friction and wear applications at high PV values and/or at elevated temperatures above a critical temperature (such as T_{g} or melting point) while retaining dimensional stability and mechanical properties to provide higher efficiency and the ability to reduce weight of parts otherwise formed of metals or ceramics and thereby make processes more energy efficient and cost effective. In preferred embodiments herein such compositions and articles may also provide improved chemical resistance in such articles over a wide range of temperatures and allow for continued good mechanical, wear and friction properties at high temperatures and high PV conditions.

In the invention herein includes a composition for use in forming an article subject to a frictional force or for use in a tribological system, comprising at least one crosslinkable aromatic polymer matrix material which, when crosslinked, remains operable at a PV of at least about 75,000 psi-ft./min. In a preferred embodiment, the at least one crosslinkable aromatic polymer matrix material, when crosslinked may remain operable at a PV of about 75,000 psi-ft./min to about 100,100 psi-ft./min. In a further embodiment, the at least one crosslinkable aromatic polymer matrix material, when crosslinked, has a PV limit measured in psi-ft./min. at about 500° F. that is at least about 10% higher than a PV limit measured in psi-ft./min at about 500° F. of an uncrosslinkable version of the same aromatic polymer matrix material. Preferably the PV limit is at least about 20% higher, and more preferably about 50% higher.

In one embodiment, the at least one crosslinkable aromatic polymer matrix material is a crosslinkable polymer selected from polyarylenes, polysulfones, polyethersulfones, polyphenylene sulfides, polyphenylene oxides, polyimides, polyetherimides, thermoplastic polyimides, polybenzamide, polyamide-imide, polyurea, polyurethane, polyphthalamide, polybenzimidazole, polyaramid, and blends, co-polymers, and alloys thereof. The at least one crosslinkable aromatic polymer preferably is a crosslinkable polyarylene selected from polyetherketone, polyetheretherketone, polyetherdiphenylether ketone, polyetherketone ketone, and blends, co-polymers and alloys thereof.

The at least one crosslinkable aromatic polymer may comprise one or more functionalized groups for crosslinking. The at least one crosslinkable polymer may be a polyarylene ether having repeating units along its backbone according to the structure of formula (I):

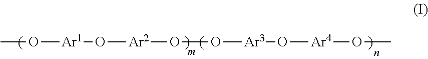

wherein Ar¹, Ar², Ar³ and Ar⁴ are identical or different aryl radicals, m=0 to 1, and n=1-m.

The at least one crosslinkable aromatic polymer in the composition in one embodiment may have repeating units along its backbone having the structure of formula (II):

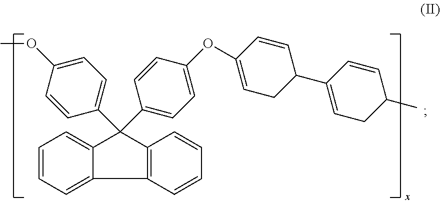

or of formula (IIa):

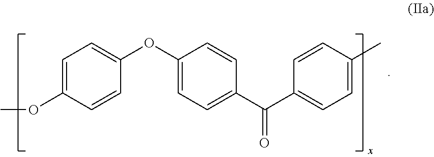

In a further embodiment, the at least one crosslinkable polymer may comprise a first crosslinkable polymer that is one or more polyarylene selected from polyetherketone, polyetheretherketone, polyetherdiephenylether ketone, polyetherketone ketone, and blends, co-polymers and alloys thereof a second crosslinkable polymer selected from the group consisting of (i) polyphenylene sulfide; (ii) one or more of polysulfone, polyphenylsulfone, polyethersulfone, co-polymers and alloys thereof, and (iii) one or more of polyimide, thermoplastic polyimide, polyetherimide, and blends, co-polymers and alloys thereof.

The composition may comprise the at least one crosslinkable aromatic polymer and further comprise at least one crosslinking compound that has a structure according to one of the following formulae:

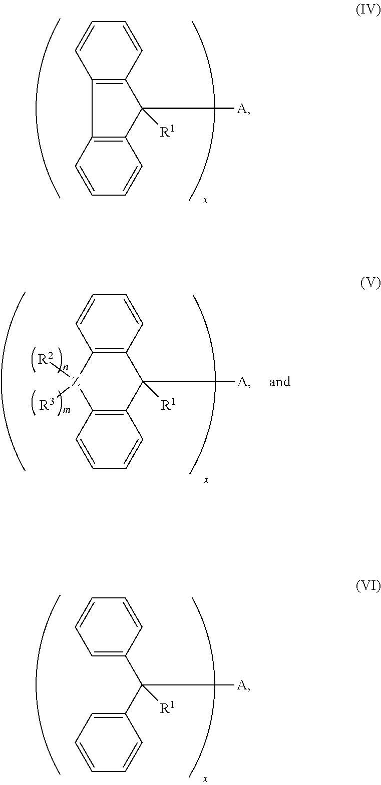

wherein A is a bond, an alkyl, an aryl, or an arene moiety having a molecular weight less than about 10,000 g/mol; wherein R¹, R², and R³ are the same or different and are independently selected from the group consisting of hydrogen, hydroxyl (—OH), amine (NH₂), halide, ester, ether, amide, aryl, arene, or a branched or straight chain, saturated or unsaturated alkyl group of one to about six carbon atoms; wherein m is from 0 to 2, n is from 0 to 2, and m+n is greater than or equal to zero and less than or equal to two; wherein Z is selected from the group of oxygen, sulfur, nitrogen, and a branched or straight chain, saturated or unsaturated alkyl group of one to about six carbon atoms; and wherein x is about 1 to about 6.

In such an embodiment, the at least one crosslinking compound may have a structure according to formula (IV) and is selected from the group consisting of

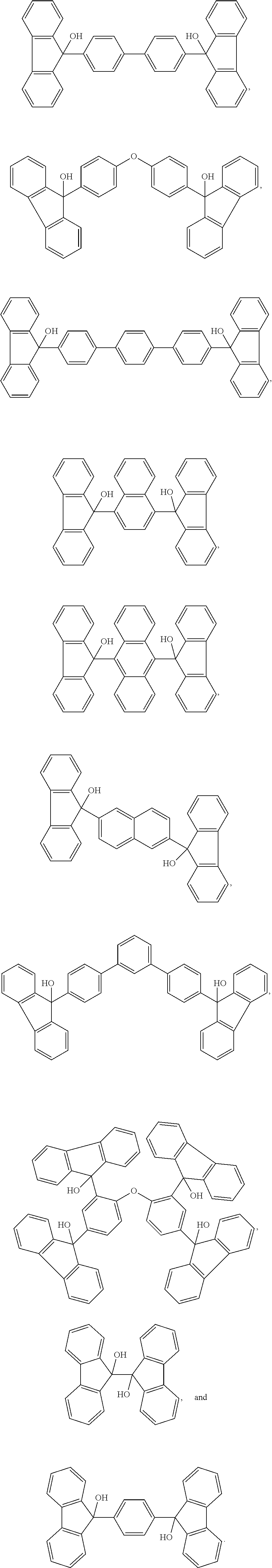

It may also have at least one crosslinking compound has a structure according to formula (V) and is selected from a group consisting of:

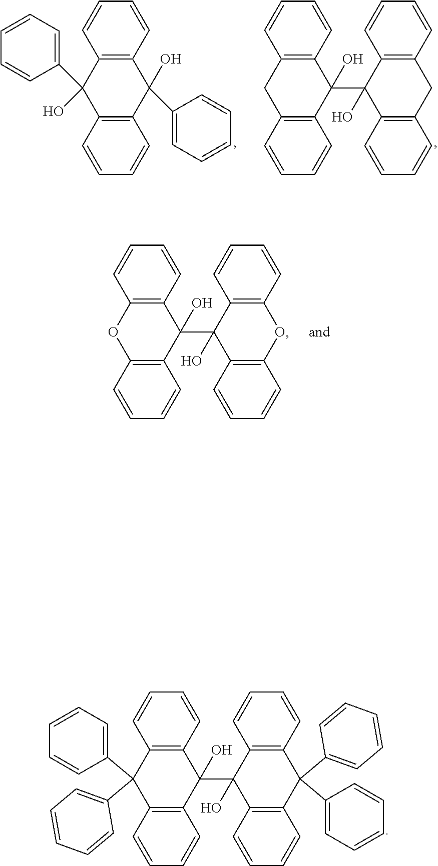

Further, the at least one crosslinking compound may have a structure according to formula (VI) and is selected from the group consisting of

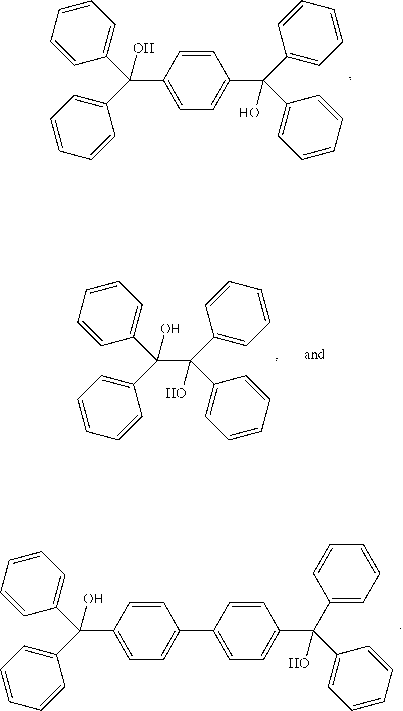 [SMILES: OC(c1ccccc1)(c1ccccc1)c1ccc(C(O)(c2ccccc2)c2ccccc2)cc1 ; OC(c1ccccc1)(c1ccccc1)C(O)(c1ccccc1)c1ccccc1 ; OC(c1ccccc1)(c1ccccc1)c1ccc(-c2ccc(C(O)(c3ccccc3)c3ccccc3)cc2)cc1]

In one embodiment of the composition including a crosslinking compound, the crosslinking compound may have the formulae as noted above in formulae (IV), (V) and (VI), wherein A has a molecular weight of about 1,000 g/mol to about 9,000 g/mol. The at least one crosslinking compound if used may be present in the composition in an amount of about 1% by weight to about 50% by weight of an unfilled weight of the composition. A preferred weight ratio of the crosslinkable aromatic polymer to the crosslinking compound in the composition is about 1:1 to about 100:1.

When using a crosslinking compound, the composition may further comprise a crosslinking reaction control additive selected from a cure inhibitor or a cure accelerator. The crosslinking reaction control additive may be present in the composition in an amount of about 0.01% to about 15% by weight of the crosslinking compound. The crosslinking reaction control additive may be a cure inhibitor comprising lithium acetate. The crosslinking reaction control additive is a cure accelerator comprising magnesium chloride.

The composition may also include one or more additives selected from continuous or discontinuous, long or short, reinforcing fibers selected from carbon fibers, glass fibers, woven glass fibers, woven carbon fibers, aramid fibers, boron fibers, polytetrafluoroethylene fibers, ceramic fibers, polyamide fibers; and/or one or more fillers selected from carbon black, silicate, fiberglass, glass beads, glass spheres, milled glass, calcium sulfate, boron, ceramic, polyamide, asbestos, fluorographite, aluminum hydroxide, barium sulfate, calcium carbonate, magnesium carbonate, silica, aluminum nitride, aluminum oxide, borax (sodium borax), activated carbon, pearlite, zinc terephthalate, graphite, graphene, talc, mica, silicon carbide whiskers or platelets, nanofillers, molybdenum disulfide, fluoropolymer fillers, boron nitride, nanodiamond, microdiamond, carbon nanotubes and fullerene tubes. Preferably such the one or more additives and/or one or more fillers comprise about 0.5% by weight to about 65% by weight in the composition. The composition according to claim 19, wherein the one or more additives is selected from carbon fiber, glass fiber, PTFE, and graphite.

The invention further includes an article formed from a composition as described above. Such articles may be, for example, but not limited to rotary and reciprocating components selected from downhole tool components, an aerospace components, vehicle components, a semiconductor manufacturing component, and a tool having a rotating or reciprocating component. Such components may be for example, but not limited to a gear, a rotor, a drill bit, a pulley, a bearing, and a seal.

In a further embodiment herein, the invention includes a composition for use in forming an article subject to a frictional force or for use in a tribological system, comprising at least one crosslinkable aromatic polymer matrix material; and one or more additives selected from continuous or discontinuous, long or short, reinforcing fibers selected from carbon fibers, glass fibers, woven glass fibers, woven carbon fibers, aramid fibers, boron fibers, polytetrafluoroethylene fibers, ceramic fibers, polyamide fibers; and/or one or more fillers selected from carbon black, silicate, fiberglass, glass beads, glass spheres, milled glass, calcium sulfate, boron, ceramic, polyamide, asbestos, fluorographite, aluminum hydroxide, barium sulfate, calcium carbonate, magnesium carbonate, silica, aluminum nitride, aluminum oxide, borax (sodium borax), activated carbon, pearlite, zinc terephthalate, graphite, graphene, talc, mica, silicon carbide whiskers or platelets, nanofillers, molybdenum disulfide, fluoropolymer fillers, boron nitride, nanodiamond, microdiamond, carbon nanotubes and fullerene tubes.

In such an embodiment, the composition may comprise about 0.5% by weight to about 65% by weight of the one or more additives and/or one or more fillers. The one or more additives may be preferably selected from carbon fiber, glass fiber, PTFE, and graphite.

In this such embodiment, the at least one crosslinkable aromatic polymer matrix material may be a crosslinkable polymer selected from polyarylenes, polysulfones, polyethersulfones, polyphenylene sulfides, polyphenylene oxides, polyimides, polyetherimides, thermoplastic polyimides, polybenzamide, polyamide-imide, polyurea, polyurethane, polyphthalamide, polybenzimidazole, polyaramid, and blends, co-polymers, and alloys thereof. The at least one crosslinkable may also be preferably a crosslinkable polyarylene selected from polyetherketone, polyetheretherketone, polyetherdiphenylether ketone, polyetherketone ketone, and blends, co-polymers and alloys thereof. The at least one crosslinkable aromatic polymer may comprise one or more functionalized groups for crosslinking. In one embodiment of such composition, the at least one crosslinkable polymer is a polyarylene ether having repeating units along its backbone according to the structure of formula (I):

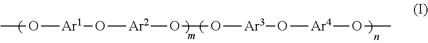

wherein Ar¹, Ar², Ar³ and Ar⁴ are identical or different aryl radicals, m=0 to 1, and n=1-m.

For example, the least one crosslinkable aromatic polymer in the composition of this embodiment may also have repeating units along its backbone having the structure of formula (II):

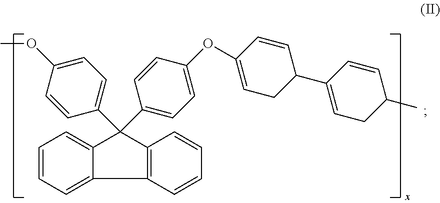

or formula (IIa):

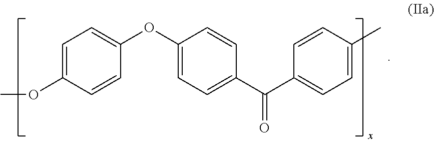

Further, in such an embodiment of the composition, the at least one crosslinkable polymer comprises a first crosslinkable polymer that is one or more polyarylene selected from polyetherketone, polyetheretherketone, polyetherdiephenylether ketone, polyetherketone ketone, and blends, co-polymers and alloys thereof and a second crosslinkable polymer selected from the group consisting of (i) polyphenylene sulfide; (ii) one or more of polysulfone, polyphenylsulfone, polyethersulfone, co-polymers and alloys thereof, and (iii) one or more of polyimide, thermoplastic polyimide, polyetherimide, and blends, co-polymers and alloys thereof.

The composition may comprise the at least one crosslinkable aromatic polymer and further comprise at least one crosslinking compound that has a structure according to one of the following formulae:

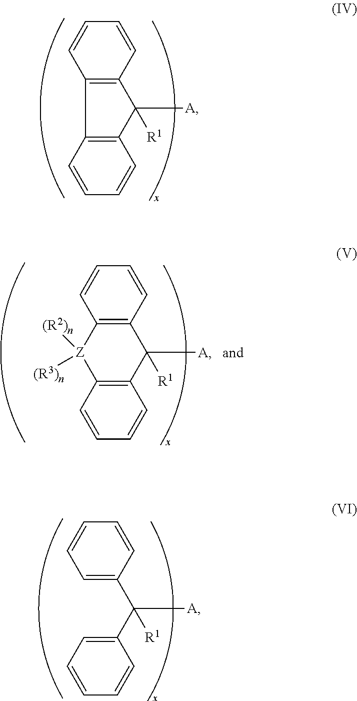

wherein A is a bond, an alkyl, an aryl, or an arene moiety having a molecular weight less than about 10,000 g/mol; wherein R¹, R², and R³ are the same or different and are independently selected from the group consisting of hydrogen, hydroxyl (—OH), amine (NH₂), halide, ester, ether, amide, aryl, arene, or a branched or straight chain, saturated or unsaturated alkyl group of one to about six carbon atoms; wherein m is from 0 to 2, n is from 0 to 2, and m+n is greater than or equal to zero and less than or equal to two; wherein Z is selected from the group of oxygen, sulfur, nitrogen, and a branched or straight chain, saturated or unsaturated alkyl group of one to about six carbon atoms; and wherein x is about 1 to about 6.

The invention further includes a method of improving the wear resistance of an article formed from a composition, wherein the article is for use in a high PV end application in which it is subject to a frictional force or used in a tribological system, comprising providing to the composition at least one crosslinkable aromatic polymer matrix material which, when crosslinked, remains operable at a PV of at least about 75,000 psi-ft./min; crosslinking the at least one crosslinkable aromatic polymer in the composition; and forming the article. In one embodiment the at least one crosslinkable aromatic polymer matrix material, when crosslinked remains operable at a PV of about 75,000 psi-ft./min to about 100,100 psi-ft./min. In the method, the PV limit of the composition for forming the article may also be raised by providing to the composition at least one crosslinkable aromatic polymer matrix material which, when crosslinked, has a PV limit measured in psi-ft./min. at about 500° F. that is at least about 10% higher than a PV limit measured in psi-ft./min at about 500° F. of an uncrosslinkable version of the same aromatic polymer matrix material. Preferably the PV limit may be at least about 20% higher, and more preferably about 50% higher. The method may further comprise providing to the composition one or more additives selected from carbon fiber, glass fiber, PTFE, and graphite.

In yet a further embodiment, the invention includes a composition for use in forming an article subject to a frictional force or for use in a tribological system, comprising a matrix material selected from polytetrafluoroethylene, modified polytetrafluoroethylenes, and at least one aromatic polymer; and at least one crosslinked aromatic polymer filler material, wherein the at least one crosslinked aromatic polymer filler material.

In such a composition the wear resistance of the composition may be at least about 200% greater than a composition having the same matrix material and a filler material of the same aromatic polymer that is not crosslinked, preferably least about 250% greater than a composition having the same matrix material and a filler material of the same aromatic polymer that is not crosslinked, and even more preferably up to about 850% greater than a composition having the same matrix material and a filler material of the same aromatic polymer that is not crosslinked. The at least one crosslinked aromatic polymer filler material may further have a PV limit measured in psi-ft./min. at about 500° F. that is at least about 20% higher than a PV limit of an uncrosslinkable version of the same aromatic polymer matrix material, preferably the PV limit is at least about 50% higher than a PV limit of an uncrosslinkable version of the same aromatic polymer matrix material.

The at least one crosslinked aromatic polymer filler may be formed by providing a composition comprising at least one or more crosslinkable aromatic polymers and crosslinking at least one of the crosslinkable aromatic polymers in the composition and forming the composition into at least one of pellets, platelets or particles.

The at least one crosslinkable aromatic polymer may comprise one or more functionalized groups for crosslinking. The at least one crosslinkable polymer may comprises a first crosslinkable polymer that is one or more polyarylene selected from polyetherketone, polyetheretherketone, polyetherdiephenylether ketone, polyetherketone ketone, and blends, co-polymers and alloys thereof and a second crosslinkable polymer selected from the group consisting of (i) polyphenylene sulfide; (ii) one or more of polysulfone, polyphenylsulfone, polyethersulfone, co-polymers and alloys thereof, and (iii) one or more of polyimide, thermoplastic polyimide, polyetherimide, and blends, co-polymers and alloys thereof.

The at least one crosslinked aromatic polymer filler material is a crosslinked polymer may be selected from polyarylenes, polysulfones, polyethersulfones, polyphenylene sulfides, polyphenylene oxides, polyimides, polyetherimides, thermoplastic polyimides, polybenzamide, polyamide-imide, polyurea, polyurethane, polyphthalamide, polybenzimidazole, polyaramid, and blends, co-polymers, and alloys thereof.

The at least one crosslinked aromatic polymer filler material may be a crosslinked polyarylene selected from polyetherketone, polyetheretherketone, polyetherdiphenylether ketone, polyetherketone ketone, and blends, co-polymers and alloys thereof. The at least one crosslinkable polymer may be, for example, a polyarylene ether having repeating units along its backbone according to the structure of formula (I):

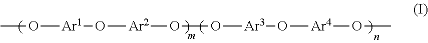

wherein Ar1, Ar2, Ar3 an Ar4 are identical or different aryl radicals, m=0 to 1, an n=1-in.

The at least one crosslinkable aromatic polymer may further have repeating units along its backbone having the structure of formula (II):

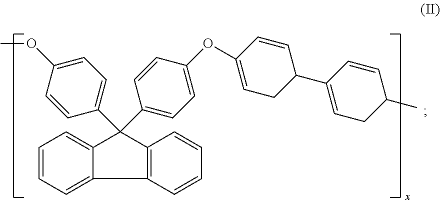

or formula (IIa):

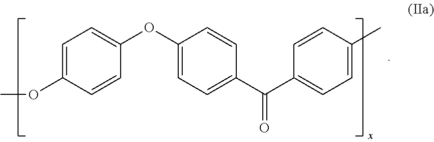

The composition may also comprise at least one crosslinking compound that has a structure according to one of the following formulae:

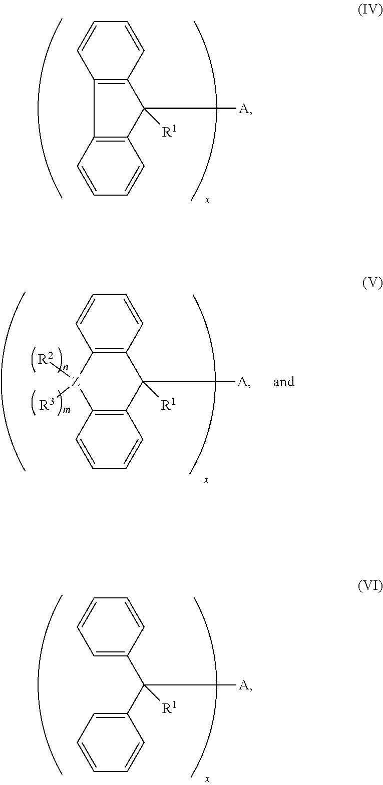

wherein A is a bond, an alkyl, an aryl, or an arene moiety having a molecular weight less than about 10,000 g/mol; wherein R¹, R², and R³ are the same or different and are independently selected from the group consisting of hydrogen, hydroxyl (—OH), amine (NH₂), halide, ester, ether, amide, aryl, arene, or a branched or straight chain, saturated or unsaturated alkyl group of one to about six carbon atoms; wherein m is from 0 to 2, n is from 0 to 2, and m+n is greater than or equal to zero and less than or equal to two; wherein Z is selected from the group of oxygen, sulfur, nitrogen, and a branched or straight chain, saturated or unsaturated alkyl group of one to about six carbon atoms; and wherein x is about 1 to about 6.

Examples of the at least one crosslinking compound including those having a structure according to formula (IV) and may be selected from the group consisting of

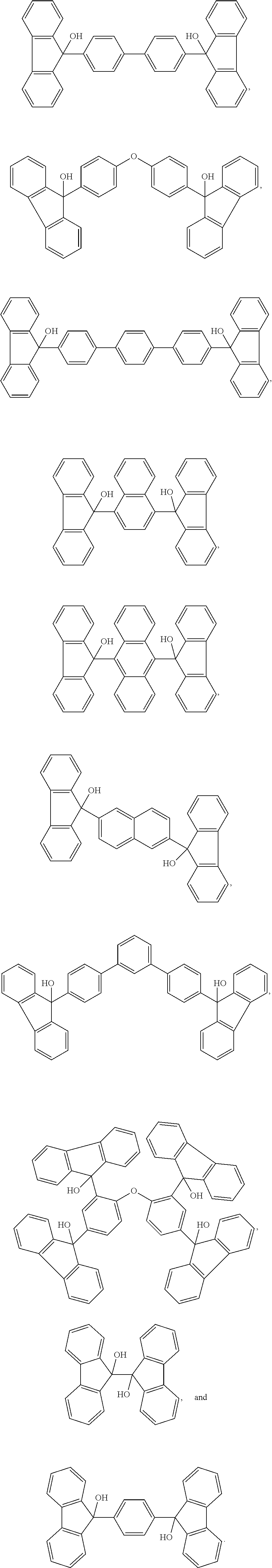

The at least one crosslinking compound may have a structure according to formula (V) and can be selected from a group consisting of:

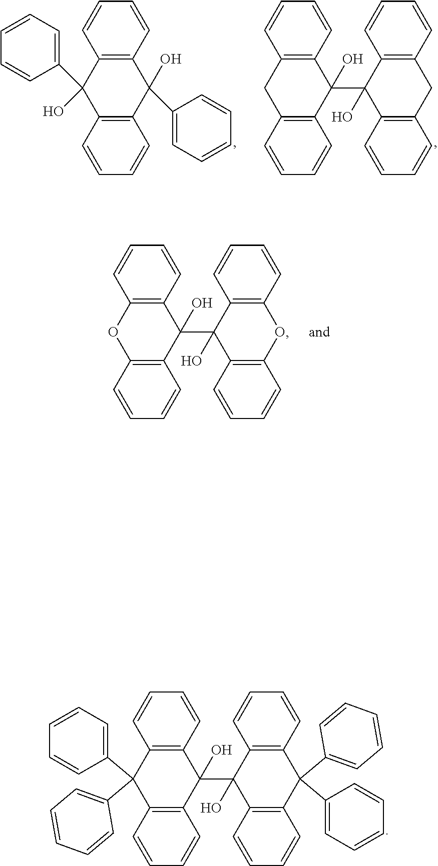

The at least one crosslinking compound may have a structure according to formula (VI) and may be selected from the group consisting of

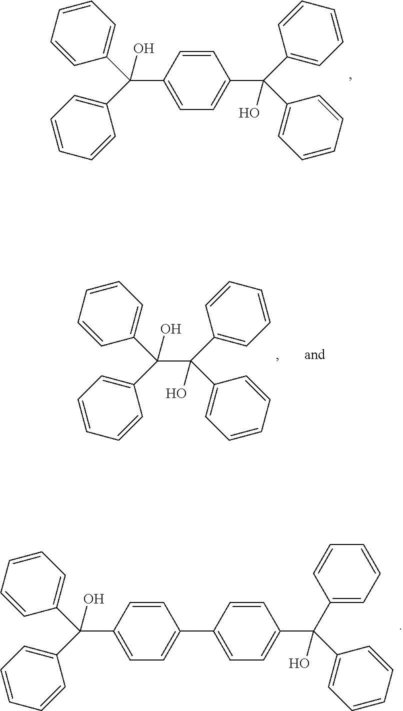 [SMILES: OC(c1ccccc1)(c1ccccc1)c1ccc(C(O)(c2ccccc2)c2ccccc2)cc1 ; OC(c1ccccc1)(c1ccccc1)C(O)(c1ccccc1)c1ccccc1 ; OC(c1ccccc1)(c1ccccc1)c1ccc(-c2ccc(C(O)(c3ccccc3)c3ccccc3)cc2)cc1]

In the formulae noted above, A may have a molecular weight of about 1,000 g/mol to about 9,000 g/mol. The at least one crosslinking compound may be present in the composition in an amount of about 1% by weight to about 50% by weight of an unfilled weight of the composition. A preferred weight ratio of the crosslinkable aromatic polymer to the crosslinking compound in the composition is about 1:1 to about 100:1.

The composition may further comprise a crosslinking reaction control additive selected from a cure inhibitor or a cure accelerator. The crosslinking reaction control additive may be present in the composition in an amount of about 0.01% to about 15% by weight of the crosslinking compound. The crosslinking reaction control additive may be a cure inhibitor comprising lithium acetate. The crosslinking reaction control additive may be a cure accelerator comprising magnesium chloride.

The composition may comprise one or more additives selected from continuous or discontinuous, long or short, reinforcing fibers selected from carbon fibers, glass fibers, woven glass fibers, woven carbon fibers, aramid fibers, boron fibers, polytetrafluoroethylene fibers, ceramic fibers, polyamide fibers; and/or one or more fillers selected from carbon black, silicate, fiberglass, glass beads, glass spheres, milled glass, calcium sulfate, boron, ceramic, polyamide, asbestos, fluorographite, aluminum hydroxide, barium sulfate, calcium carbonate, magnesium carbonate, silica, aluminum nitride, aluminum oxide, borax (sodium borax), activated carbon, pearlite, zinc terephthalate, graphite, graphene, talc, mica, silicon carbide whiskers or platelets, nanofillers, molybdenum disulfide, fluoropolymer fillers, boron nitride, nanodiamond, microdiamond, carbon nanotubes and fullerene tubes.

The composition may comprise about 0.5% by weight to about 65% by weight of the one or more additives and/or one or more fillers. Preferred additives include carbon fiber, glass fiber, PTFE, and graphite.

Also included in the invention are articles formed from the compositions as noted above. The article subject to wear in use may be selected from, but not limited to, rotary and reciprocating components selected from downhole tool components, an aerospace components, vehicle components, a semiconductor manufacturing component, and a tool having a rotating or reciprocating component. For example, the article may be, but is not limited to, a gear, a rotor, a drill bit, a pulley, a bearing, and a seal.

Also within the invention is a method of improving the wear resistance of a composition for use in forming an article subject to a frictional force or for use in a tribological system, comprising providing a matrix material selected from polytetrafluoroethylene, modified polytetrafluoroethylenes, and at least one aromatic polymer; and adding to the matrix a filler material comprising at least one crosslinked aromatic polymer. The composition may have a wear resistance that is at least about 200% greater than a composition having the same matrix material and a filler material of the same aromatic polymer that is not crosslinked, preferably is at least about 250% greater than a composition having the same matrix material and a filler material of the same aromatic polymer that is not crosslinked, and may be up to about 850% greater than a composition having the same matrix material and a filler material of the same aromatic polymer that is not crosslinked. The at least one crosslinked aromatic polymer filler material may have a PV limit measured in psi-ft./min. at about 500° F. that is at least about 10% higher than a PV limit of an uncrosslinkable version of the same aromatic polymer matrix material, preferably at least about 20% higher, and most preferably is at least about 50% higher than a PV limit of an uncrosslinkable version of the same aromatic polymer matrix material.

Also within the invention is a composition for use in forming an article subject to a frictional force or for use in a tribological system, comprising at least one crosslinkable aromatic polymer matrix material which, when crosslinked, substantially maintains its dimensional stability after heating above a critical transition temperature. The critical transition temperature may be a glass transition temperature or a melting point temperature. When the at least one crosslinkable aromatic polymer matrix material is crosslinked, it preferably also avoids catastrophic failure above the critical transition temperature.

A method is provided also herein for retaining dimensional stability and/or avoiding catastrophic failure above a critical transition temperature of an article subject to a frictional force and/or used in a tribological system, comprising forming the article from the composition that comprises a crosslinked aromatic polymer; and incorporating the article in an application subject to a frictional force and/or used in a tribological system, wherein the temperature of the article in the application exceeds a critical transition temperature of the aromatic polymer in the article. The crosslinked aromatic polymer is preferably a matrix material in the article. The composition may in one embodiment comprise a polymeric matrix material and the crosslinked aromatic polymer is a filler in the polymeric matrix material. The critical transition temperature is a glass transition temperature or a melting temperature.

Also within the invention is a composition for use in forming an article subject to a frictional force or for use in a tribological system, comprising at least one crosslinkable aromatic polymer matrix material which, when crosslinked and incorporated into an article subject to a frictional force or in a tribological system, substantially retains its dimensional stability over the critical transition temperature of the crosslinked aromatic polymer in the article.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1A is a photographic representation of a thrust washer from Example 1 herein formed of an uncrosslinked PEEK wear composition before testing;

FIG. 1B is a photographic representation of the thrust washer of FIG. 1A after testing;

FIG. 1C is a photographic representation of a thrust washer from Example 1 herein formed of a crosslinked PEEK wear composition before testing;

FIG. 1D is a photographic representation of the thrust washer of FIG. 1C after testing;

FIG. 2 is a graphical representation of the impact of wear factor (10⁻¹⁰ in³ min/ft.-lb. hr.) as a function of PV (psi ft./min) for Comparative Samples A and B and inventive Sample C in Example 2;

FIG. 3 is a graphical representation of normalized wear resistance (1/K) for the wear compound in Comparative Sample E formed of PTFE with a PPS filler and for the inventive Sample D including PTFE filled with a crosslinked PEEK filler in Example 3;

FIG. 4 is a graphical representation of the wear factor of an inventive Sample H (using the crosslinked PEEK filler in inventive Sample D of Example 3) in comparison to PTFE samples filled, respectively, with uncrosslinked PEEK (Sample F) and with PPS (Sample G) as Example 4;

FIG. 5 is a graphical representation of the thickness gap (mm) changing over time during the DMA compression test of Example 5;

FIG. 6A is a photographic representation of the thrust washer of Sample 2 (uncrosslinked material) before testing from Example 5;

FIG. 6B is a photographic representation of the thrust washer of Sample 2 (uncrosslinked material) after testing from Example 5;

FIG. 6C is a photographic representation of the thrust washer of Sample 1 (crosslinked material) before testing from Example 5; and

FIG. 6D is a photographic representation of the thrust washer of Sample 1 (crosslinked material) after testing from Example 5.

### DETAILED DESCRIPTION OF THE INVENTION

The invention is directed to compositions for making articles and articles made therefrom that include aromatic polymeric materials for use as matrix materials and/or as friction additives to existing matrix materials, when such articles are used in friction and wear applications, particularly when they are employed in high PV end applications. Such compositions enable the articles when employed as matrix materials to retain dimensional stability and mechanical properties and provide higher efficiency and the ability to reduce weight of parts otherwise formed of metals or ceramics and thereby make processes more energy efficient and cost effective. Further, when used as additives in existing matrix materials or when substituted for existing matrix materials, including those which hare uncrosslinked aromatic materials, such compositions are able to improve existing friction and wear properties, particularly at high PV conditions. In preferred embodiments herein such compositions and articles also provide improved chemical resistance in such articles over a wide range of temperatures and allow for continued good mechanical, wear and friction properties at high temperatures and high PV conditions.

In one embodiment, a composition may be formed that can be employed for forming articles subject to frictional force in their intended end applications or for use in a tribological systems. Such compositions may be formed so as to include at least one crosslinkable aromatic polymer matrix material. The matrix material employed, when crosslinked, provides a PV limit, measured in psi-ft./min. at about 500° F., that is at least about 10% higher than a PV limit measured in psi-ft./min at about 500° F. of an uncrosslinkable version of the same aromatic polymer matrix material. Preferably the PV limit is at least about 20% higher, and more preferably about 50% higher. For example, use of a crosslinked polyetherether ketone as a matrix material in such a composition can provide a PV limit that is at least about 50% higher than standard polyetherether ketone that is not crosslinked.

Such crosslinked aromatic polymers as matrix materials enable formation of articles having improved tribological and wear properties, particularly for use of such compositions at elevated temperatures to improve the frictional properties including the PV limit so that polymeric materials may be employed in end applications where other wear materials in the prior art are not able to be employed.

As used herein, the terms “a” and “at least one” can mean “one or more” absent language to the contrary, such as language indicating a specific number.

As used herein, “aromatic polymer” is a polymer that includes aromatic moieties either along its polymer backbone or attached thereto, preferably it is one that incorporates an aromatic moiety (a cyclic moiety derived from an aromatic compound) in the polymer backbone. Such aromatic moieties may be a single ring and/or a multiring structures and can be linked together directly on the backbone or connected through linking species or elements, such as oxygen, sulfur, hydrogen, alkyl or other groups.

As used herein, “crosslinkable polymer” means a polymer that has groups capable of reacting with each other (self-crosslinking), capable of reacting through application of heat, radiation or light, or capable of reacting with a crosslinking agent or compound. Such groups may exist on a polymer when formed through polymerization or may be provided to the polymer through functional groups or other crosslinking groups positioned along the length of the polymer chain, or along substituents extending from the polymer chain, including terminal groups.

Crosslinked polymers herein may be formed from a composition including at least one crosslinkable polymer, as well as one or more additives, crosslinking compounds, reaction control agents or other additives or fillers. The compositions thus formed may be crosslinked using a variety of acceptable crosslinking techniques such as thermally induced crosslinking, radiation induced crosslinking, grafting crosslinkable groups on a polymer and reacting the polymer with one or more other materials and/or through chemically induced crosslinking reactions. The crosslinking may occur during and/or after molding or forming the crosslinkable aromatic polymer in the composition into a part, component or a portion thereof. As used herein, incorporation of the compositions herein into an “article” may mean that the composition forms the entire article, or forms any part, component, element, features, surface coating, fastener or other portion of the article. Further, the compositions herein may be used as a matrix material of such article or a part thereof, or may be used as a filler in an article or a part thereof.

The crosslinkable aromatic composition may also be in solvent form and applied to an existing part or core formational structure such as a formed outer layer or coating over a part or structure of the article, which coating or outer layer may then be dried and cured so as to form a part of a structure.

The compositions useful as matrix materials and/or as polymeric fillers include one or more crosslinkable aromatic polymer(s). The crosslinkable aromatic polymer(s) herein may be any of a variety of cross-linked aromatic polymers. In preferred embodiments, the crosslinkable aromatic polymer(s) are polyarylene polymers, such as a polyarylene ethers (PAE), polyarylene ketones (PAK) or polyarylene ether ketones (PAEK) and various co-polymers thereof known or to be developed in the art. The aromatic polymer compositions include an aromatic polymer that can be crosslinked and may optionally include at least one crosslinking compound.

The crosslinking of crosslinkable, aromatic polymers herein is preferably achieved either by modification of the polymer for grafted crosslinking and then exposing the aromatic polymer to sufficiently high temperatures to induce self-crosslinking of the polymer and/or by use of a crosslinkable aromatic polymer with the use of one or more crosslinking compound(s).

The aromatic polymer may be crosslinked, for example, by grafting functional groups onto the polymer backbone which can be thermally induced to crosslink the polymers, as further described in U.S. Pat. No. 6,060,170, incorporated in relevant part herein by reference. Alternatively, the crosslinkable aromatic polymer may be crosslinked by thermal action at temperatures greater than about 350° C. or more, as disclosed in U.S. Pat. No. 5,658,994, incorporated herein, in relevant part, by reference. An example of a preferred material for use in thermal crosslinking is 1,2,4,5 tetra(phenylethynyl)benzene as shown below:

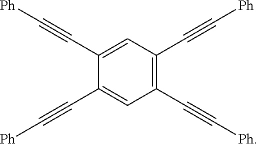 [SMILES: C(#Cc1cc(C#Cc2ccccc2)c(C#Cc2ccccc2)cc1C#Cc1ccccc1)c1ccccc1]

In a preferred embodiment of the present application, the compositions used for forming a matrix material may include and/or a filler may include or be formed of at least one crosslinkable polymer which is crosslinked using the addition of at least one crosslinking compound capable of crosslinking the aromatic polymer either across chains or to itself within the polymer matrix. Such polymers may include, either through polymerization or through functionalization, groups that enable self-crosslinking. Grafted crosslinking may also be used, provided that the crosslinked polymer formed is capable of being formed into an article or part thereof such as by use of heat molding or other part formation processes.

The crosslinkable aromatic polymer in the compositions used herein may be any of a variety of amorphous and/or semicrystalline aromatic polymers and copolymers. Preferred examples for use herein, include without limitation, polyarylene homopolymers or copolymers, including polyarylene ethers and/or polyarylene ketones, such as polyetherketone (PEK), polyetherketone ketone (PEKK), polyetherether ketone (PEEK), polyetherdiephenylether ketone (PEDEK) and the like; and may also be or may include in a blended form with a polyarylene homopolymer or copolymer, various polysulfones (PSU); polyethersulfones (PES); polyphenylene sulfides (PPS); polyphenylene oxides (PPO); polyphenylsulfones (PPSU); polyimides (PI); polyetherimides (PEI) and thermoplastic polyimides (TPI); polybenzamides (PBA); polyamide-imides (PAI); aromatic polyureas; polyurethanes (PU); polyphthalamides (PPA); polybenzimidazoles (PBI); polyaramids; aromatic copolymers of polyoxyalkylenes such as polyoxymethylenes (POM), thermoplastic aromatic polymers such as polyaramids, or similar aromatic polymers known in the art or to be developed including various copolymers and functionalized or derivatized versions of such polymers, including blends or alloys. Examples of various polyketones and polysulfone homopolymers and copolymers that are amenable to the method described herein are outlined in McGrail, “Polyaromatics,” Polymer International 41 (1996), pp. 103-120.

Of such polymers, those that are at least partly semicrystalline demonstrate improved wear properties. However, crosslinking such polymers enhances their ability to perform in wear applications without catastrophic failure at what would otherwise be their critical transition point and allows for retention of dimensional stability. For example, crosslinking of amorphous aromatic polymers, which, in non-crosslinked form, catastrophically soften at their T_{g}, allows for their use in high PV wear applications where the frictional heating would further raise the countersurface temperatures in an end application above the T_{g}.

The crosslinkable aromatic polymer(s) may be functionalized or non-functionalized as desired to achieve specific properties or as necessary for forming articles having specific operational uses or end applications, e.g., functional groups such as hydroxyl, mercapto, amine, amide, ether, ester, halogen, sulfonyl, aryl and functional aryl groups or other functional groups can be provided depending on intended end effects and properties. The aromatic polymer can also be a polymer blend, alloy, or co-polymer or other multiple monomer polymerization of two or more of such aromatic polymers, provided that one such monomer enables formation of a polymer in each case that is crosslinkable or provided that in a blend, alloy or copolymerization, at least one of the polymers is crosslinkable. Preferably, when the aromatic polymer is a blend or alloy, the aromatic polymers are chosen so as to be processible in compatible processing temperature ranges.

In an embodiment herein, the compositions may include a crosslinkable aromatic polymer(s) that is a poly(arylene ether) including polymer repeating units along its backbone having a general structure according to formula (I):

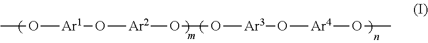

wherein Ar¹, Ar², Ar³ and Ar⁴ may be identical or different aryl radicals, m=0 to 1, and n=1-m, wherein such polymers may be of a variety of molecular weights and chain lengths depending on intended end use as is known in the relevant aromatic polymer art.

Ar radicals in Formula (I) include but are not limited to biphenyl, terphenyl, Lanthracene, naphthyl, and other polyaromatic moieties. Larger aryl structures are known in the art in order to increase Tg so that polymers may be selected or modified to be more suitable as a polymer or copolymer structure depending on the end application service temperature and desired PV limit for the wear article or tribological component. See, McGrail, as noted above.

In a further embodiment, the crosslinkable aromatic polymer(s) may be a poly(arylene ether) as in formula (I), wherein m is 1 and n is 0, and the aromatic polymer has repeating units along its backbone having a structure as shown below in formula (II):

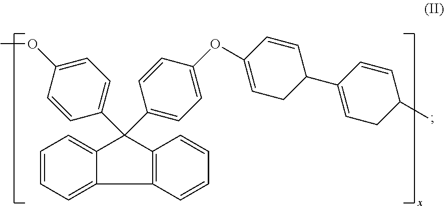

or formula (IIa):

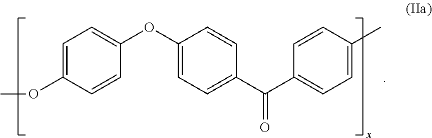

In preferred embodiments, the crosslinkable aromatic polymer(s) are one or more of polyaryletherketones (PAEK), including polyetherketone (PEK), polyetheretherketone (PEEK), polyetherketoneketone (PEKK), polyetherdiphenylether ketone (PEDEK) and polyetherketoneetherketoneketone (PEKEKK). The crosslinkable aromatic polymer may be a commercially available crosslinkable aromatic polymer as noted above. PAEKs for use in the invention are commercially available, for example as PEEK under the name Victrex™ PEEK, available from Victrex, plc; KetaSpire® PEEK from Solvay, and Vestakeep® from Evonik. Suitable copolymers of such materials including ketone and/or sulfones and other biphenyl, diphenyl and triphenyl derivatives may also be used.

In an embodiment herein in which an optional crosslinking compound(s) is/are used, such crosslinking compounds may be any such compounds which can initiate chemical crosslinking of aromatic polymers. Preferred crosslinking compounds for use with the crosslinkable aromatic polymers are described in applicant's U.S. Pat. Nos. 9,006,353 and 9,109,075, each of which is incorporated herein by reference, in relevant part, with respect to useful polymers and crosslinking compounds and crosslinking control additives which may be used herein. One such crosslinking compound is of the general structure:

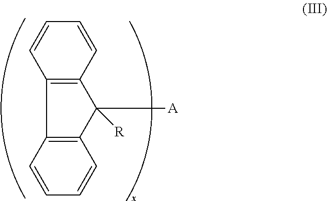

wherein R is OH, NH₂, halide, ester, amine, ether or amide, and x is 1 to 6 and A is an arene moiety having a molecular weight of less than about 10,000 g/mol. When reacted with an aromatic polymer, such as a polyarylene ketone, such crosslinking compound forms a thermally stable, cross-linked oligomer or polymer.

Such crosslinking technology enables aromatic polymers, which are otherwise difficult to crosslink, to be formed in a crosslinkable form so as to be thermally stable up to temperatures greater than 260° C. and even greater than 400° C. or more, depending on the polymer so modified, i.e., polysulfones, polyimides, polyamides, polyetherketones and other polyarylene ketones, polyphenylene sulfides, polyureas, polyurethanes, polyphthalamides, polyamide-imides, aramids, and polybenzimidazoles.

Additional crosslinking compounds for crosslinking aromatic polymers are described in applicant's co-pending, U.S. Patent Publications Nos. 2020-0172667 A1 and 2020-0172669 A1 which include one or more of the crosslinking compounds according to any of the following structures:

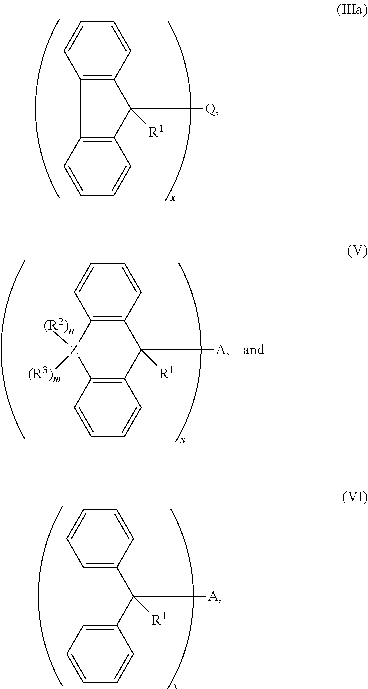

wherein Q is a bond and A may be Q, an alkyl, an aryl, or an arene moiety having a molecular weight less than about 10,000 g/mol. Each of R¹, R², and R³ may be the same or different and may be independently selected from the group consisting of hydrogen, hydroxyl (—OH), amine (—NH₂), halide, ester, ether, amide, aryl, arene, or a branched or straight chain, saturated or unsaturated alkyl group, preferably of one to about six carbon atoms. Formula (IIIa) is substantially the same as formula (III) above, with the exception that the moiety A in formula (III) is replaced by Q (which represents a bond) and R¹ of formula (IIIa) is defined differently than R of formula (III).

In formula (V), m is preferably from 0 to 2, n is preferably from 0 to 2, and m+n is greater than or equal to zero and less than or equal to two. Further, in formula (V), Z is preferably selected from the group of oxygen, sulfur, nitrogen, and a branched or straight chain, saturated or unsaturated alkyl group of one to about six carbon atoms. In any of formulae (IIIa), (V) and (VI), as with formula (III), x is also about 1 to about 6.

The compositions used in the articles and methods of the present invention to form articles or tribological components subject to wear that are preferably capable of operation at high PV conditions may include aromatic crosslinkable polymer(s) and a blend of one or more crosslinking compounds. In another embodiment, the composition may be used that includes a single crosslinking compound that can be selected based upon the aromatic polymer in the composition including the at least one crosslinkable polymer.

In a further embodiment, crosslinking compounds may be added to the composition including the at least one crosslinkable polymer for use in forming a crosslinked polymer that is suitable as a matrix material or filler that is part of an article according to the present invention may include structures according to one of the following formulae:

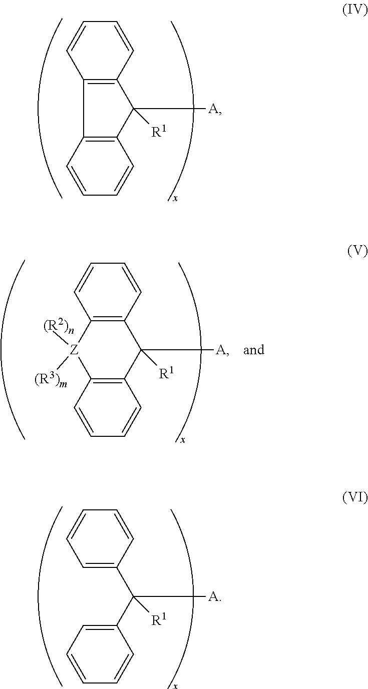

In each of formulae (IV)-(VI), A may be a bond, an alkyl, an aryl, or an arene moiety preferably having a molecular weight less than about 10,000 g/mol. A molecular weight of less than about 10,000 g/mol permits the overall structure to be more miscible with the aromatic polymer, and permits uniform distribution, with few or no domains, within the composition including the aromatic polymer and crosslinking compound. More preferably, A has a molecular weight from about 1,000 g/mol to about 9,000 g/mol. Most preferably, A has a molecular weight from about 2,000 g/mol to about 7,000 g/mol.

The moiety A may be varied to have different structures, including, but not limited to the following

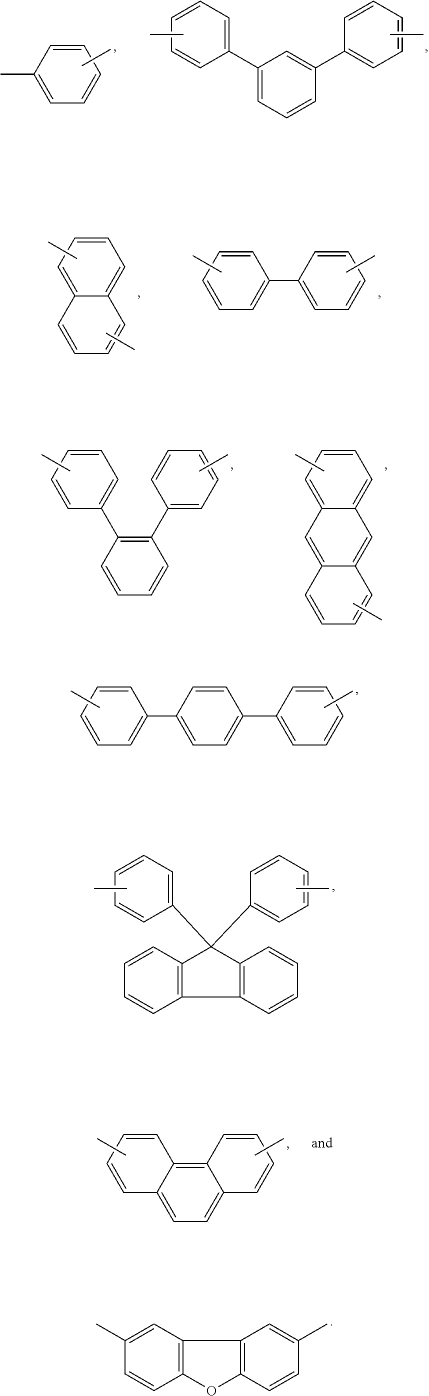

Further, the moiety A may be functionalized, if desired, using one or more functional groups such as, e.g., and without limitation, sulfate, phosphate, hydroxyl, carbonyl, ester, halide or mercapto or the other functional groups noted above.

In formulas (IV) and (VI), R¹ is preferably selected from the group consisting of hydrogen, hydroxyl (—OH), amine (NH₂), halide, ester, ether, amide, aryl, arene, or a branched or straight chain, saturated or unsaturated alkyl group of preferably one to about six carbon atoms.

In formula (V), R¹, R², and R³ may be the same or different and are preferably independently selected from the group consisting of hydrogen, hydroxyl (—OH), amine (NH₂), halide, ester, ether, amide, aryl, arene, or a branched or straight chain, saturated or unsaturated alkyl group of preferably one to about six carbon atoms. Thus, R¹, R², and R³ may each be different, two of R¹, R², and R³ may be the same with the third being different, or each of R¹, R², and R³ may be the same. Further, in formula (V), m is preferably from 0 to 2, n is preferably from 0 to 2, and m+n is preferably greater than or equal to zero and less than or equal to two. Thus, in formula (V), one or two R² groups may be present, one or two R³ groups may be present, one R² group and one R³ group may be present, or R² and R³ may both be absent. In formula (V), Z is preferably selected from the group of oxygen, sulfur, nitrogen, and a branched or straight chain, saturated or unsaturated alkyl group of one to about six carbon atoms. In any of formulas (IV)-(VI), x is preferably about 1 to about 6.

In embodiments having a crosslinking compound according to formula (IV), the crosslinking compound may have a structure according to one or more of the following:

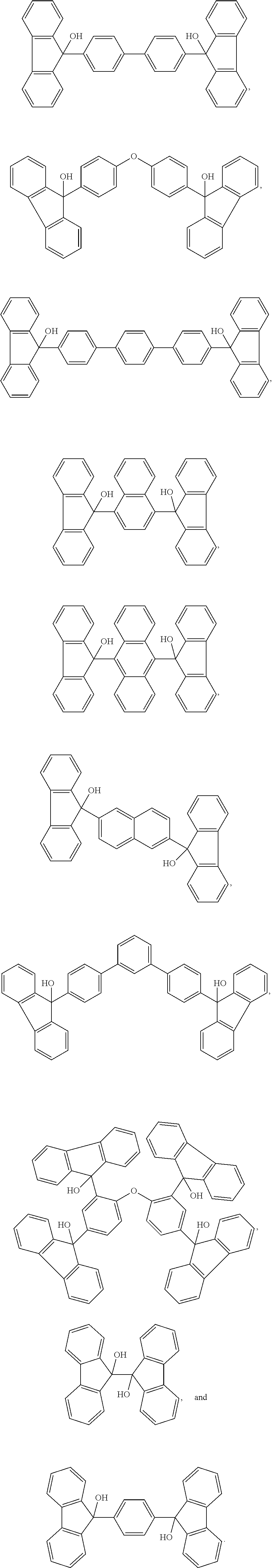

The above-listed crosslinking compounds are not intended to be limiting and are merely provided as examples of crosslinking compounds according to formula (IV). In the above crosslinking compounds of formula (IV), R¹ is shown as being a hydroxyl group. The moiety, A, is shown as being any of various aryl groups, and x is shown as being either 2 or 4.

In embodiments having a crosslinking compound of formula (V), the crosslinking compound may have a structure according to one or more of the following:

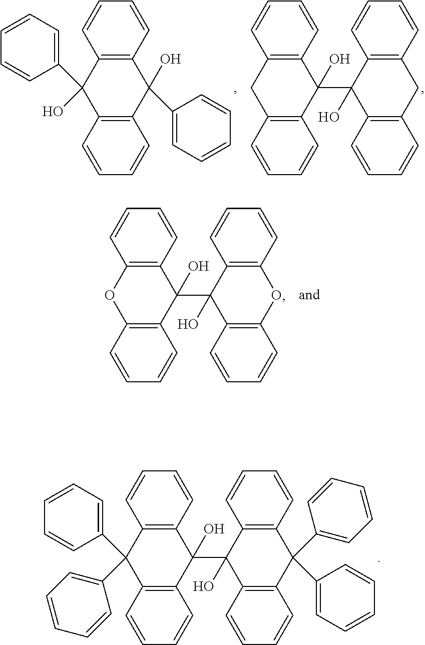

The above-listed crosslinking compounds are not intended to be limiting and are merely provided as examples of crosslinking compounds according to formula (V). In the above crosslinking compounds of formula (V), Z is shown as being an alkyl group with one carbon atom or O. R¹ is shown as being a hydroxyl group. R² and R³ are shown as being the same, different or not present. The moiety A is shown as being a bond or an aryl group. Further, x is shown as being 1 or 2.

In embodiments in which the crosslinking compound has a structure according to formula (VI), the crosslinking compound may have one or more of the following structures:

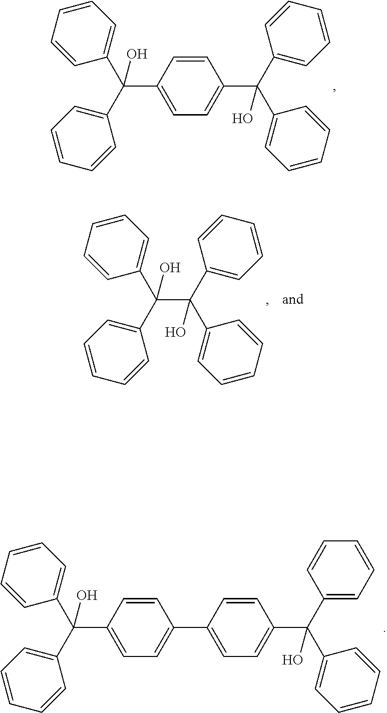 [SMILES: OC(c1ccccc1)(c1ccccc1)c1ccc(C(O)(c2ccccc2)c2ccccc2)cc1 ; OC(c1ccccc1)(c1ccccc1)C(O)(c1ccccc1)c1ccccc1 ; OC(c1ccccc1)(c1ccccc1)c1ccc(-c2ccc(C(O)(c3ccccc3)c3ccccc3)cc2)cc1]

The above-listed crosslinking compounds are not intended to be limiting and are merely provided as examples of crosslinking compounds according to formula (VI). In the above compounds of formula (VI), R¹ is shown as a hydroxyl group. The moiety A is shown as being a bond or an aryl group. Further, x is shown as being 2.

The amount of crosslinking compound(s) for use with crosslinkable aromatic polymers in a composition to be used to form an article and/or a matrix material as described herein is/are (collectively) preferably about 1% by weight to about 50% by weight, 5% by weight to about 30% by weight or about 10% to about 35%, or about 8% by weight to about 24% by weight based on the total weight of an unfilled composition of the crosslinkable aromatic polymer and the crosslinking compound.

The compositions used herein may have a weight ratio of the crosslinkable aromatic polymer to the crosslinking compound that is preferably about 1:1 to about 100:1. More preferably, the weight ratio of the aromatic crosslinkable polymer to the crosslinking compound in the composition is about 3:1 to about 10:1.

The compositions may optionally further include crosslinking reaction additive(s) for controlling the cure reaction rate during formation of the wear articles and/or components in tribological systems and during any post-treatment processing. Such additive(s) may be mixed into the composition in varying amounts depending on the end properties and cross-linking density desired for the wear articles. The use of a crosslinking reaction control additive(s) for controlling cure reaction rate, i.e., crosslinking rate and extent, will also depend upon the cure reaction kinetics of a particular aromatic polymer and the crosslinking compound used.

The amount of the crosslinking compound typically impacts the degree of cross-linking such that use of particular levels of crosslinking compound can provide the desired degree of crosslinking and crosslink density. The use of a crosslinking reaction control additive for controlling cure reaction rate, i.e., crosslinking rate and extent, will also depend upon the cure reaction kinetics of a particular aromatic polymer and the crosslinking compound used, and so may be adjusted to help to control the reaction rate for a given composition. Generally, the higher the degree of crosslinking and crosslink density, the higher the PV conditions that can be tolerated without failure.

Thus the crosslinking reaction control additive included can be a cure inhibitor (a Lewis base agent), such as lithium acetate for reactions with a high reaction rate, or the crosslinking reaction additive may be a cure accelerator (a Lewis acid agent) when the cure reaction rate is too slow, such as magnesium chloride or other rare earth metal halides. When the composition includes a crosslinking reaction control additive, the amount of crosslinking reaction control additive in the composition is preferably about 0.01% to about 5% by weight based on the weight of the crosslinking compound, but may be adjusted depending on the reaction rate achieved in a given system.

The above compositions may be formed to have blends of crosslinkable aromatic polymers in the composition. Such blends include two or more such polymers. Providing control to the reaction allows for it to occur earlier or later in the process of forming and article or in a process to provide variations in physical properties such as hardness, T_{g} or other critical transition point, compressive modulus, shear modulus, toughness (elongation at break), tensile strength and other desired properties, as well as consistency, dimensional stability, and surface hardness properties to wear articles.

When using the blends of two or more crosslinkable aromatic polymers, if the aromatic polymers are self-crosslinkable and/or many be thermally crosslinked, a crosslinking compound may not be necessary and crosslinkable aromatic polymers that have different crosslinking reaction rates may be used together to modify or control the overall crosslinking rate. This is described in detail in applicant's co-pending U.S. Patent Application Publication No. 2021-0388216 A1, incorporated herein by reference.

The level of crosslinking may be adjusted for achieving desired mechanical and wear properties for use in wear articles and/or as components in a tribological system. Generally, higher levels of a crosslinking compound will tend to form a stiffer product with less ductility after a full cure cycle. For forming wear articles and/or components in a tribological system, the compositions herein may be used to balance the need to process the compositions (i.e., its processability) with desired physical and wear properties. Higher levels of crosslinking will improve friction and wear properties and the ability to retain operation and dimensional stability in high PV applications, but may in some instances do so at the expense of processability as well as formability of the articles or components. Thus, depending on the physical properties of a given composition, if more processability is desired, the crosslinking level may be adjusted to balance the desired friction and/or wear properties of the component and/or article being made, and/or the reaction rate or additives may be used for minor modifications in those properties. Further, if blending of materials is being used to control reaction rate, the blends may also be similarly adjusted.

The compositions for use as matrix materials for forming polymeric wear articles herein and/or for use in forming polymeric fillers that may be used in forming polymeric wear articles herein, may further be filled or reinforced with one or more additives to improve or otherwise modify the modulus, impact strength, bonding strength, dimensional stability, heat resistance, and/or insulation properties and/or to further modify the wear or tribology properties in articles formed using the compositions described herein. Preferably, such additives is/are selected from one or more of continuous or discontinuous, long or short, reinforcing fibers selected from one or more of carbon fibers, glass fibers, woven glass fibers, woven carbon fibers, aramid fibers, boron fibers, polytetrafluoroethylene (PTFE) fibers, ceramic fibers, polyamide fibers, and/or one or more fillers selected from carbon black, silicate, fiberglass, glass beads, glass spheres, milled glass, calcium sulfate, boron, ceramic, polyamide, asbestos, fluorographite, aluminum hydroxide, barium sulfate, calcium carbonate, magnesium carbonate, silica, aluminum nitride, borax (sodium borax), activated carbon, pearlite, zinc terephthalate, graphite, graphene, talc, mica, silicon carbide whiskers or platelets, nanofillers, molybdenum disulfide, fluoropolymer fillers, boron nitride, nanodiamond, microdiamond, carbon nanotubes and fullerene tubes. Particularly preferred for use in forming wear articles of such additives are carbon fiber, graphite and PTFE fillers. Additives may also be chosen in order to assist in modifying the coefficient of thermal expansion (CTE) for dimensional stability of formed articles, including fillers that would reduce the CTE of the polymer in the compositions for articles herein if desired, e.g., glass fibers, milled glass, glass beads, mica, aluminum oxide and/or talc.

The additives may additionally or alternatively include other thermal management fillers, including but not limited to nanodiamonds and other carbon allotropes, polyhedral oligomeric silsesquioxane (“POSS”) and variants thereof, silicon oxides, boron nitrides, and aluminum oxides. The additives may additionally or alternatively include flow modifiers, such as ionic or non-ionic chemicals.

The additive(s) may include an optional CTE-reducing additive as noted above and/or an optional reinforcing fiber which is a continuous or discontinuous, long or short fiber, that is carbon fiber, PTFE fiber, glass fiber and/or graphite. Most preferably, the additive is a reinforcing fiber that is a continuous, long fiber. For example, if minimizing CTE in specific directions is indicated, such continuous, long fiber additives would be indicated. If minimizing the overall CTE is desired, more isotropic fillers may be preferred such as graphite, milled fiber, and the like.

The crosslinkable polymer compositions may comprise about 0.5% to about 65% by weight of additives in the composition, and more preferably about 5% to about 40% by weight of additives in the composition. The crosslinkable polymer compositions may further comprise one or more of stabilizers, tribological or rheological adjustment additives, flame retardants, pigments, colorants, plasticizers, surfactants, or dispersants. Preferred additives include friction modifiers such as PTFE, graphite, molybdenum sulfide, fibrous fillers for enhancing modulus and/or hardness and CTC modification. Most preferably PTFE, graphite and carbon fiber are incorporated in the compositions for use in forming wear articles and/or components for use in a tribological system.

In one embodiment herein, the invention provides a composition for use in forming an article subject to a frictional force or for use in a tribological system as described above, including at least one or more of the crosslinkable aromatic polymers described herein as the matrix material and further including with such polymers one or more additives selected from continuous or discontinuous, long or short, reinforcing fibers selected from carbon fibers, glass fibers, woven glass fibers, woven carbon fibers, aramid fibers, boron fibers, polytetrafluoroethylene fibers, ceramic fibers, polyamide fibers; and/or one or more fillers selected from carbon black, silicate, fiberglass, glass beads, glass spheres, milled glass, calcium sulfate, boron, ceramic, polyamide, asbestos, fluorographite, aluminum hydroxide, barium sulfate, calcium carbonate, magnesium carbonate, silica, aluminum nitride, aluminum oxide, borax (sodium borax), activated carbon, pearlite, zinc terephthalate, graphite, graphene, talc, mica, silicon carbide whiskers or platelets, nanofillers, molybdenum disulfide, fluoropolymer fillers, boron nitride, nanodiamond, microdiamond, carbon nanotubes and fullerene tubes. Other additives, such as crosslinking compounds as described herein may also be used. The one or more additives should be present in an amount of about 0.5% by weight to about 65% by weight collectively based on the weight of the total composition. The preferred additives in such an embodiment of the invention are carbon fiber, glass fiber, PTFE and/or graphite will enhance the property performance of the cross-linked polymer in articles formed from the compositions herein, particularly at higher PV levels such as 75,000 psi-ft./min or more, and up to about 100,100 psi-ft./min. In such a composition, the preferred crosslinkable aromatic polymers are those noted above herein, and such polymers may include functionalized group(s) for crosslinking. Such compositions may also include crosslinkable polymer blends as noted in this disclosure and may use the various crosslinking compounds described herein.

The compositions herein may be prepared by providing the crosslinkable aromatic polymer(s) and optionally a crosslinking compound capable of crosslinking the aromatic polymer(s) and combining the aromatic polymer and the crosslinking compound. If self-crosslinkable polymers or grafted polymers are used, the crosslinking compound may be omitted. If the crosslinking compound is used in the composition it is preferably combined with the aromatic polymer to form a preferably substantially homogeneous composition.

Incorporation of the crosslinking compound(s) into the crosslinkable aromatic polymer(s) can be performed by various methods, such as by solvent precipitation, mechanical blending or melt blending. Preferably, the crosslinkable polymer compositions are formed by dry powder blending of the crosslinking compound and aromatic polymer, such as by conventional non-crosslinked polymer compounding processes, including, for example, twin-screw compounding. The resulting composition can be extruded into filaments or fibers, or can be used as a powder, platelets or pellets for use as polymeric fillers or for use in forming articles. However, articles may be formed directly or while crosslinking into articles from the compositions without first forming pellets or the like.

Blending (including blending of more than one crosslinkable aromatic polymer) may be accomplished further by use of an extruder, such as a twin-screw extruder, a ball mill, or a cryogrinder. Blending of the crosslinkable aromatic polymer(s) and crosslinking compound(s) is preferably conducted at a temperature during blending that does not exceed about 250° C. so as to preferably avoid premature curing during the blending process. If a melt process is used, care should be taken to ensure thermal history and temperature exposure are minimized, i.e., it is preferred to use short residence times and/or as low temperature as feasible to achieve material flow. Alternatively, use of rate controlling additives as described above and/or the blending of crosslinkable aromatic polymers of differing reaction kinetics, may be used to inhibit curing and/or control the curing rate to minimize any crosslinking due to compounding and conversion into a pellet or fiber form.

Depending on the polymer and components selected in the composition, the material may be formed into powder, fiber, filament, platelet, or pellet form for use in a matrix material such as the matrix materials herein or the matrices of other known wear compositions such as those formed of polytetrafluoroethylene or modified polytetrafluoroethylenes or blends of such materials. As used herein, “modified polytetrafluoroethylenes” or “modified PTFEs” is intended to encompass both copolymerized versions of polymerized TFE or PTFE, as well as homopolymerized PTFE that has been modified through external, physico-chemical impulses and the like, or by chemical grafting or other chemical modification such as to provide a functionalized group for specific purposes. For forming articles from the compositions herein, including the crosslinkable polymer(s) and any additive components selected, such articles for wear use may first be formed as fibers, filaments, platelets, pellets or powder and then be formed such as be heat molding or extrusion into an article or may be formed while crosslinking directly into an article without first forming into pellets, etc.

In forming fillers and/or articles from the compositions herein, crosslinking may occur at least partially or fully during and/or after formation of the article. Suitable crosslinking additives are known in the art and are described in U.S. Pat. No. 9,109,080 noted above, which is incorporated herein, in relevant part, with respect to the cross-linking control additives.

As the blending process may be exothermic, it is necessary to control the temperature, which can be adjusted as necessary and to temperatures indicated depending upon the particular crosslinkable aromatic polymer(s) selected for use. In mechanical blending of the aromatic polymer and crosslinking compound, the resulting composition is preferably substantially homogenous in order to obtain uniform crosslinking.

When the composition is prepared, it can be cured by exposure to a temperature greater than 250° C., for example at a temperature of about 250° C. to about 500° C. However, when and to what extent to subject the composition to heat and crosslinking during a forming process will depend upon the desired properties to be achieved in the end product. For example, greater crosslinking may create higher levels of mechanical strength or hardness, but could impact processability or ductility. Preferred levels of crosslinking are about 1% to about 50%, which can be achieved by modifying the level of crosslinking compound, adjusting any crosslinking reaction control additives and/or modifying any blend ratio when using blended polymers to control crosslinking.

Thus, it is possible to form a desired article using a crosslinkable polymer in a composition as noted above and to crosslink during formation such as by heat molding, such as injection molding, extrusion molding, or insert molding a part or portion of a part, and then further curing for shaping and to complete crosslinking. It is also possible to fully crosslink the material and then heat mold the part. Finally, it is possible to form a part of a different underlying core material that is preferably also able to perform in high temperature applications and apply the composition to an exterior of the core materials, such as by coating or molding a layer on an exterior thereof, or otherwise joining or molding parts or materials together.

When forming articles from the compositions herein using heating molding techniques as noted above, including injection molding, care should be taken to control process parameters to ensure successful forming of the crosslinked compositions and/or blended compositions into articles. For crosslinked compositions, careful control of temperature and shear rate should be maintained to avoid exceeding the critical temperature for the compositions, including when the crosslinked aromatic polymer is used as a wear matrix material or when used as a filler in a wear matrix material, and also to determine and control a critical shear rate. Thus processing within controlled shear and temperature parameters (as well as controlling crosslinking rates as noted elsewhere herein) will avoid exceeding such critical temperature and shear limits.

If such critical limits are exceeded premature initiation of the crosslinking reaction may take place during the forming process or excessive process crosslinking may take place, which can cause insufficient or poor formation of resulting articles or component parts thereof. Control of these parameters, which may vary depending on the crosslinkable aromatic polymer being used and its crosslinking reaction rate and conditions, can avoid negative impacts on processability and article formation which would be evident from a partial or lack of fill in the final article (i.e., short shots), excessive foaming of the heated polymeric composition in the article and/or excessive or premature initiation of crosslinking of the crosslinkable aromatic polymer in the feed apparatus of the heat molding equipment, such as in the barrel of an injection molding machine, which can damage the components of the machine and would not successfully mold parts. Such parameters can be evaluated within the ability of one skilled in the art, depending on the selected crosslinkable aromatic polymer using its critical temperature and critical shear rate and by evaluating the relevant crosslinking reaction and any associated crosslinking compounds employed. Modeling of the compositions and/or their properties using DMA or other similar evaluation techniques may be used to provide guidance and estimation of critical parameters for the crosslinkable aromatic polymer properties and the properties of the crosslinked material prior to establishing the critical process control parameters for a particular composition within the scope of the inventive compositions described herein. Consideration of such control parameters may also be used to influence design of or modification of equipment for processes incorporating the inventive compositions herein, such as, for example, in determining a runner design and/or a screw design in plasticating the heated composition prior to molding articles therefrom.

With respect to desired wear article properties, the degree of cross-linking (cross-link density) may be varied or adjusted to provide different properties top the wear articles and to avoid potential cracking and warping during use. Such properties include hardness, T_{g} or other critical transition point, compressive modulus, shear modulus, toughness (elongation at break), tensile strength and other desired properties, as well as consistency, dimensional stability, and surface hardness properties and frictional properties such as wear resistance and a desired coefficient of friction as well as a sufficiently high PV limit. Cross-link density may be controlled when using compositions having a crosslinking compound by varying the concentration of the crosslinking compound and/or by controlling the amount of any optional crosslinking reaction additive used in conjunction with the crosslinking compound. The extent of cure, i.e., the completion of the crosslinking reaction, is related to both thermal activation of the reaction if driven by changes in temperature, as well as practical concerns involving the rate of cure.

In an embodiment using a blend of two crosslinkable polymers of different kinetics as described herein and in applicant's pending U.S. Patent Application Publication No. 2021-0388216 A1, the crosslinking rate may be controlled not only by modifying the amount of any crosslinking compound used, but also by altering the amount of the crosslinking polymer having the slower curing reaction rate used in the blend. The level of crosslinking may be adjusted for achieving desired mechanical end properties. Generally, higher levels of a crosslinking compound will tend to form a stiffer product with less ductility after a full cure cycle. For forming a wear article crosslinking levels of about 1% to about 50% are recommended, although they may be higher or lower depending on desired end properties, such as those noted above, including hardness, T_{g} or other critical transition point, compressive modulus, shear modulus, toughness (elongation at break), tensile strength and other desired properties, as well as consistency, dimensional stability, and surface hardness properties and frictional properties such as wear resistance and a desired coefficient of friction as well as a sufficiently high PV limit.

In some instances herein, the compositions may be blended or used in a liquid system. In such case, the composition may further be prepared by dissolving both the crosslinkable aromatic polymer and any crosslinking compound in a common solvent and removing the common solvent via evaporation or by the addition of a non-solvent to cause precipitation of both the polymer and any crosslinking compound from the solvent. For example, depending upon the aromatic polymer and crosslinking compound selected, the common solvent may be tetrahydrofuran, and the non-solvent may be water. An additional option for polymers and crosslinking additives that are soluble in the same solvent is the use of solvent casting or dip coating of a substrate such that, for example, a wear article may be formed wherein the interior or core of the article need not be a crosslinked aromatic polymer and the aromatic polymer may be applied to an exterior of a molded core in a thickness sufficient to provide desired wear and mechanical properties on the exterior of the article where it is subject to wear and high temperature operation provided the core of the article is not negatively impacted by the use conditions. In such a case, the crosslinkable polymer(s) and any crosslinking compounds and/or additives would be dissolved in a suitable solvent and then applied to a core molded of a high PV material or metal having a shape which may be the same or different from the outer dip-coated portion of the article. The solvent would be removed in a controlled manner, and the uncured outer portion of the article could then be cured using various techniques such as application of heat or radiation, and/or by chemically induced cross-linking. For example, an inner molded core of any suitable shape may be formed of a different polymer and an outer coating of at least one crosslinked aromatic polymer may be formed around the core to provide the desired outer shape and curved features on the article as desired.

Suitable core materials may be formed of other materials such as ceramics, for example, alumina, metals, metal alloys, organic or inorganic core materials, or various polymeric materials, such as non-crosslinked or crosslinked polymers, wherein the core material may have some desired properties suitable for the intended end use, such as adequate strength or other physical properties, but may lack desirable surface frictional and/or wear properties for an intended end use. The crosslinked polymer compositions herein may be used to coat or encapsulate the core material to improve such surface frictional and/or wear properties of the core material.

In preparing a composition for forming an article as a matrix material and/or as a polymeric filler herein, it is preferred that any optional additives are added to the composition along with or at the same time the crosslinking compound is combined with the crosslinkable aromatic polymer(s) to make the crosslinkable polymer composition. However, the specific manner of providing reinforcing fibers or fillers to the composition before further formation may be according to various techniques for incorporating such materials and should not be considered to limit the scope of the invention.

Articles formed from the composition as described above can be quite varied and are those useful in end applications that are subject to frictional wear and/or as one or more component surfaces that form a tribological system. Such articles may be, for example, but not limited to rotary and reciprocating components such as, but not limited to downhole tool components, aerospace components, vehicle components, semiconductor manufacturing components, and tools having a rotating or reciprocating component or end use. Examples include, but are not limited to gears, rotors, drill bits, pulleys, bearings, and seals.

Such compositions noted herein may be used further in a method of improving the PV limit of compositions for use in forming articles subject to frictional forces or for use as one or more of the sliding friction surfaces in a tribological system. This may be done by providing to such compositions at least one crosslinkable aromatic polymer matrix material which, when crosslinked, has a PV limit measured in psi-ft./min. at about 500° F. that is at least about 10% higher than a PV limit measured in psi-ft./min at about 500° F. of an uncrosslinkable version of the same aromatic polymer matrix material; and crosslinking the at least one crosslinkable aromatic polymer in the composition. Preferably the PV limit in the method is at least about 20% higher, and more preferably about 50% higher.

Similarly, existing wear compositions such as those having matrix materials formed of the compositions herein, or existing prior art matrix materials for wear components such as PTFE, or modified PTFEs alone or combined with other polymers, or other non-crosslinked aromatic polymers and the like may be improved by incorporating therein a filler formed from the compositions herein having crosslinked aromatic polymers therein. Such fillers may be incorporated by blending or adding at the time of article formation to improve the wear properties of the matrix material and increase its PV limit, modifying its K factor or reducing its coefficient of friction. Such materials also provide chemical resistance and in most instances, enhanced mechanical properties to the matrix material.

The compositions known herein may also be used for forming articles subject to frictional force and/or for use in a tribological systems. Such compositions may include at least one crosslinkable aromatic polymer matrix material as described herein which, when crosslinked, substantially maintains its dimensional stability after heating above a critical transition temperature. By “substantially maintaining dimensional stability” herein, it is meant that the article retains an operable shape and configuration, has not undergone catastrophic failure or melted into any operational equipment in the end application into which the article is employed, and preferably also continues to operate within acceptable tolerance or performance levels in a frictional end application or tribological system. Such tolerance levels or performance standards may be those set by industry standards setting organizations, such as, but not limited to, ISO standards, or other accepted standards which may be used or applied in various technological industries in which the wear end application is employed. The critical transition temperature may be a glass transition temperature or a melting point temperature as noted above herein. When the at least one crosslinkable aromatic polymer matrix material is crosslinked, it preferably also avoids catastrophic failure above the critical transition temperature.

A method for retaining dimensional stability and/or avoiding catastrophic failure above a critical transition temperature of an article subject to a frictional force and/or used in a tribological system can also be carried out herein by forming such an article from a composition herein that comprises a crosslinked aromatic polymer; and then using or otherwise incorporating the article into an end application that is subject to a frictional force and/or used in a tribological system. The temperature of the article in the end application may exceed a critical transition temperature of the aromatic polymer in the article. The article preferably also still retains stability as well as avoiding catastrophic failure in the end application. The crosslinked aromatic polymer is preferably a matrix material in the article, however, the composition may be a composition such as wear compositions noted herein that may in one embodiment incorporate a polymeric matrix material incorporating the crosslinked aromatic polymer as a filler in the polymeric matrix material. The critical transition temperature in such a method is a glass transition temperature or a melting temperature as discussed elsewhere herein.

The invention will now be described with respect to the following non-limiting Examples:

### Example 1

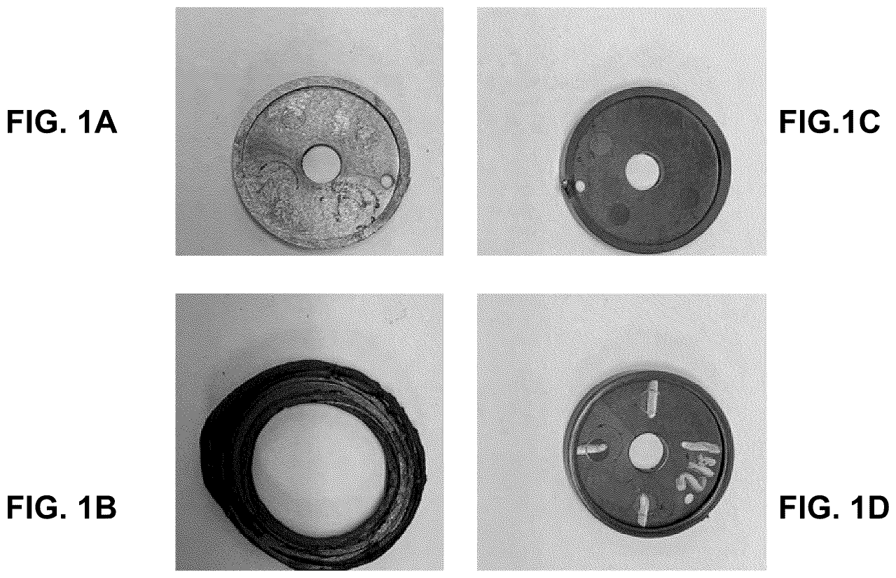

Thrust washer samples (Sample 1) were formed using compositions according to the invention by heat molding a crosslinkable composition as noted herein using a commercial crosslinked aromatic polymer based on crosslinkable polyetherether ketone, i.e., Arlon® 3000 XT having 12% crosslinking at 0% in the matrix (such that a 70% matrix having 30% additives included 8.4% crosslinking) and including wear additives 10% PTFE, 10% graphite and 10% carbon fiber for PEEK grade use. A comparative thrust washer sample (Comparative Sample 2) was formed from the same base polymer, polyetherether ketone that was not crosslinked, and that included the same wear additives in the same amounts as was used in Sample 1. The Sample 1 and Comparative Sample 2 thrust washer samples were formed according to ASTM D-3702 and subjected to the thrust washer test of that standard. The Samples were not heated, but subject to frictional energy that raised the temperature above the melting point of the polymer at the contact surface. They were subjected to cycling at a PV of 75,000 (a velocity of 150 ft/min. for 60 hours. After the test, the crosslinked material Sample 1 substantially retained its original dimensions and shape, and were functional after 16 hours of testing (See FIGS. 1C and 1D). The uncrosslinked material that formed Sample 2 melted and at failure the sample was distorted. Photographic images of the test samples of the uncrosslinked material Sample 2 before and after the test are shown in FIGS. 1A and 1B. Photographic images of a test sample having the matrix material that is formed from Arlon 3000XT (Sample 1) are shown in FIGS. 1C and 1D, before and after the test, respectively.

### Example 2

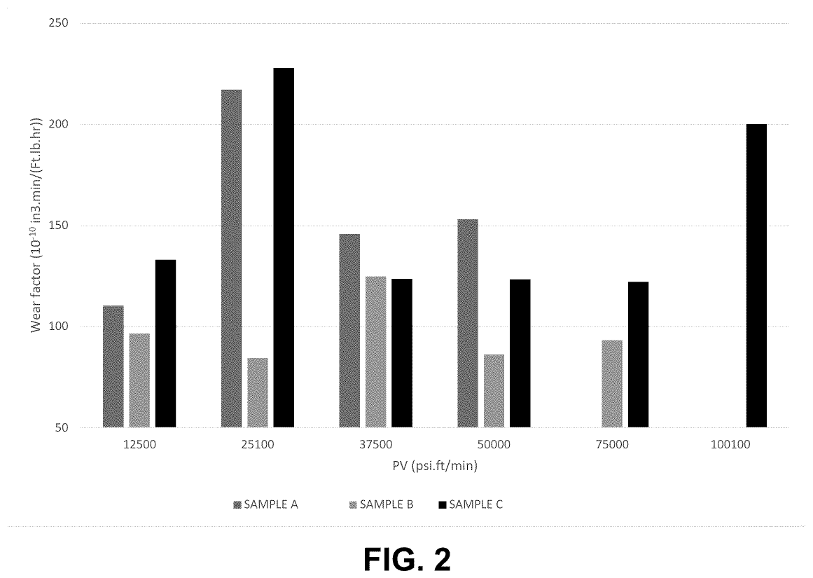

In this Example, three wear compositions were prepared, Comparative Samples A and B, and inventive Example C. Comparative Sample A was a commercial uncrosslinked PEEK wear compound from RTP (RTP 2299×81382). Sample B was an uncrosslinked PEEK wear compound including 10% graphite, 10% carbon fiber and 10% PTFE fillers and Sample C was included the same additives noted above for Sample B, but used a 17% crosslinked PEEK as a matrix material within the PTFE matrix. The resulting wear factor K, as shown in FIG. 2, demonstrates an increase in wear factor at PVs up to about 25100 PV, then a leveling off of wear factor up through about 50,000 PV, however, as the PV increased to 75,000, Sample A was no longer operable. Sample B failed over 75,000 and Sample C remained operable and substantially retained its dimensional shape even up to 100,100 PV. Sample C shows improvements in wear factor as well as the ability to perform at higher PV when the same polymer in uncrosslinked format in Sample B was unable to remain operable.

### Example 3

In this Example, all samples were tested using the ASTM D3702 wear test noted in Example 1 at PV conditions ranging from 10000 to 50000 PV. Outputs of this test are wear factors K (thickness), J (Weight) and Coefficient of friction. An inventive sample (Sample D) was prepared by providing as a polymeric filler, a crosslinked PEEK. In this Example, a commercially available Arlon® 3000XT crosslinked PEEK was used and was ground to a 50-100 micron powder and added to a PTFE wear matrix material. Other fillers were used in an equivalent wear grade, including carbon flour and molybdenum disulfide which were present as minor components. In Sample D, the crosslinked aromatic polymeric filler was added in an amount of 10% to the PTFE wear matrix.

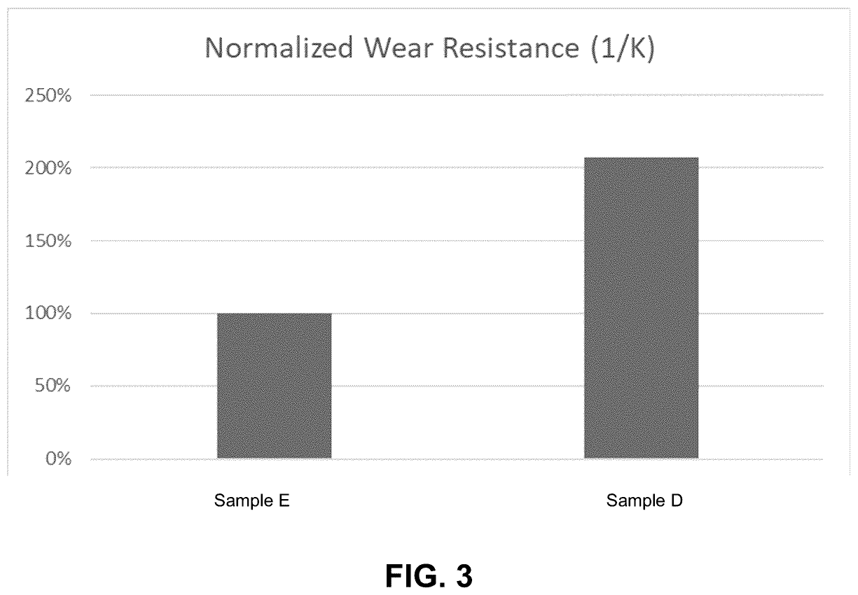

A Comparative Sample E was used that is a PTFE wear material having a polyphenylene sulfide (PPS) filler and including carbon flour as a minor component wear grade additive. Sample D was compared to Sample E and the wear factor K/thickness change was calculated. The normalized wear resistance (1/K) of each sample is shown in FIG. 3. Samples were tested using the D3702 thrust washer test noted above, and the wear factors were collected. Wear resistance was then calculated as the reciprocal of the wear factor. To better compare relative improvements 1/k values were normalized to the inventive sample.

FIG. 3 shows a 210% improvement in wear resistance for the inventive Sample D having the crosslinked aromatic polymer additive along with other fillers in a PTFE wear matrix when compared against a common representative wear grade PTFE material (Comparative Sample E).

### Example 4

In this Example, Comparative Samples F and G were prepared, which each included a PTFE wear matrix. Further an inventive Sample H was prepared by mixing a PTFE wear matrix filled with the crosslinked filler used in inventive Sample D of Example 3. Comparative Sample F was similarly formed using an uncrosslinked PEEK filler, and Comparative Sample G was also similarly formed using a PPS filler. Thus, this Example used three binary blends as is customary in the art for comparison evaluation of new additives with commercial grade fillers already in use. The uncrosslinked PEEK in Comparative Sample F, the PPS in Comparative Sample G and the crosslinked PEEK filler of Sample H were each added to their respective PTFE matrix in the same amount nominally at 15% of the PTFE matrix in the binary blends.

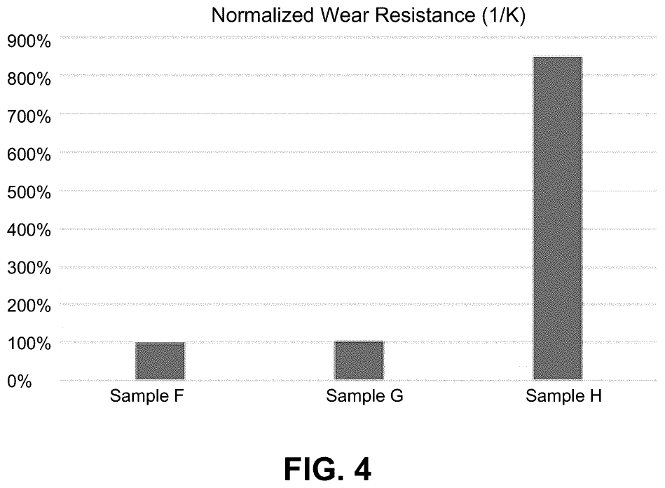

The wear factor was evaluated using the same ASTM D-3702 test run at 10,000 PV. Wear resistance was then calculated as the reciprocal of the wear factor. To better compare relative improvements 1/k values were normalized to the inventive sample. The normalized wear resistance (1/K) of each of Comparative Samples F and G and Sample H is shown in FIG. 4.

FIG. 4 demonstrates that, unlike other representative polymeric fillers used in known wear compounds in the prior art, i.e., the uncrosslinked PEEK (in Comparative Sample F) and PPS (in Comparative Sample G), the binary blend made incorporating the crosslinked polyetherether ketone filler of inventive Samples D and H demonstrated 850% higher wear resistance.

Collectively, FIGS. 3 and 4 in Examples 3 and 4 above show significant improvements in wear resistance and wear factor for the inventive Sample D having the crosslinked aromatic polymer additive in a representative PTFE wear matrix material with other standard wear compound fillers and for Sample H (using that same crosslinked aromatic polymer filler as Sample D) also demonstrated a significant increase in wear resistance over compositions having the same matrix, but different prior art wear additives.

### Example 5

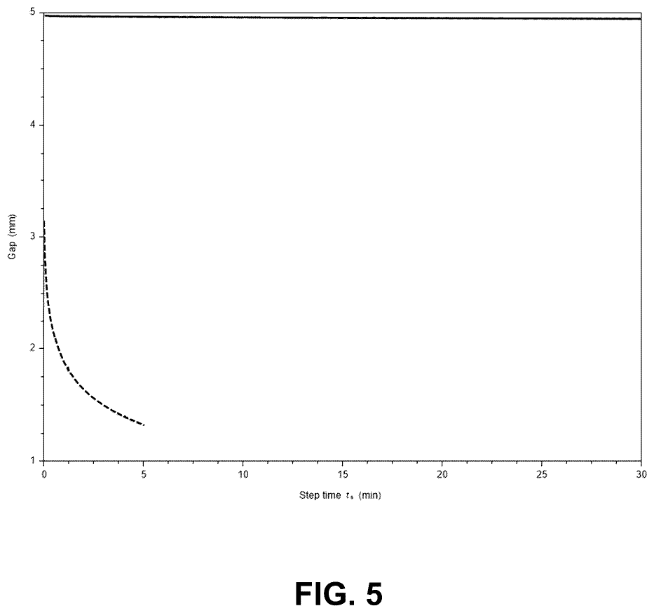

Dynamic Mechanical Analysis (DMA) testing was used to simulate temperature above the critical wear transition temperature. The thrust washer samples from Example 1 (Samples 1 and 2), were further simulated to test dimensional stability of the Samples above the critical transition temperature under static pressure. Temperature above the melting point of the material was selected as a critical transition temperature to simulate an extreme surface temperature in an aggressive application to evaluate minimizing catastrophic failure. The thrust washer sample was under 16 psi at 380° C. for 30 min. using a compression fixture in an RSA G2 DMA (from TA Instruments). The thickness change of the Sample during holding was recorded as gap movement as indicated in FIG. 5. In FIG. 5, the solid line represents the uncrosslinked Sample 2, and the dashed line represents the crosslinked Sample 1.

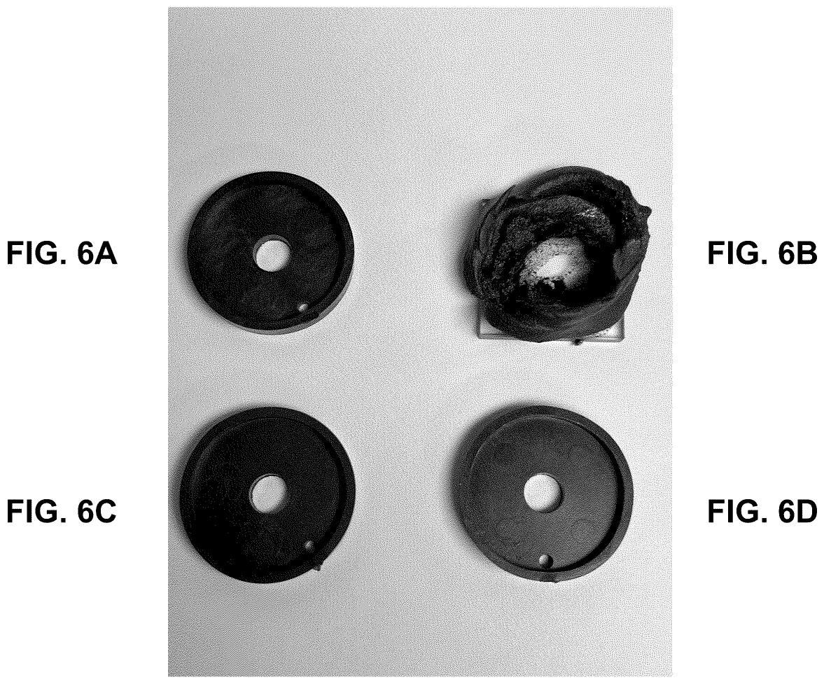

Before the 16 psi holding, the Samples were soaked and after the holding, as shown in FIG. 5 and in the photographs in FIG. 6, the uncrosslinked Sample 2 was in catastrophic failure in the soaking stage after running and holding only for 5 minutes. The crosslinked Sample 1 advantageously maintained its dimensional stability above the critical transition temperature demonstrating retention of dimensional stability and minimizing catastrophic failure in aggression conditions.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A composition for use in forming an article subject to a frictional force or for use in a tribological system, comprising
at least one crosslinkable aromatic polymer matrix material which, when crosslinked, remains operable at a PV of at least about 75,000 psi-ft./min.

2. The composition according to claim 1, wherein the at least one crosslinkable aromatic polymer matrix material, when crosslinked remains operable at a PV of about 75,000 psi-ft./min to about 100,100 psi-ft./min.

3. The composition according to claim 1, wherein the at least one crosslinkable aromatic polymer matrix material, when crosslinked, has a PV limit measured in psi-ft./min. at about 500° F. that is at least about 10% higher than a PV limit measured in psi-ft./min at about 500° F. of an uncrosslinkable version of the same aromatic polymer matrix material.

4. The composition according to claim 3, wherein the PV limit when crosslinked, measured in psi-ft./min. at about 500° F. is at least about 20% higher than a PV limit of an uncrosslinkable version of the same aromatic polymer matrix material.

5. The composition according to claim 4, wherein the PV limit when crosslinked, measured in psi-ft./min. at about 500° F. is at least about 50% higher than a PV limit of an uncrosslinkable version of the same aromatic polymer matrix material.

6. The composition according to claim 1, wherein the at least one crosslinkable aromatic polymer matrix material is a crosslinkable polymer selected from polyarylenes, polysulfones, polyethersulfones, polyphenylene sulfides, polyphenylene oxides, polyimides, polyetherimides, thermoplastic polyimides, polybenzamide, polyamide-imide, polyurea, polyurethane, polyphthalamide, polybenzimidazole, polyaramid, and blends, co-polymers, and alloys thereof.

7. The composition according to claim 6, wherein the at least one crosslinkable aromatic polymer is a crosslinkable polyarylene selected from polyetherketone, polyetheretherketone, polyetherdiphenylether ketone, polyetherketone ketone, and blends, co-polymers and alloys thereof.

8. The composition according to claim 7, wherein the at least one crosslinkable aromatic polymer comprises one or more functionalized groups for crosslinking.

9. The composition according to claim 7, wherein the at least one crosslinkable polymer is a polyarylene ether having repeating units along its backbone according to the structure of formula (I): 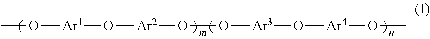
wherein Ar¹, Ar², Ar³ and Ar⁴ are identical or different aryl radicals, m=0 to 1, and n=1-m.

10. The composition according to claim 9, wherein the at least one crosslinkable aromatic polymer has repeating units along its backbone having the structure of formula (II): 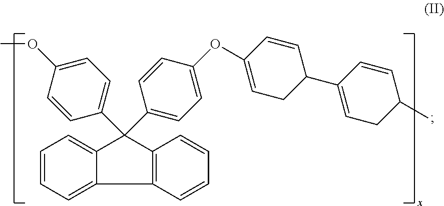
formula (IIa):

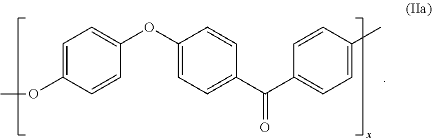

11. The composition according to claim 6, wherein the at least one crosslinkable polymer comprises a first crosslinkable polymer that is one or more polyarylene selected from polyetherketone, polyetheretherketone, polyetherdiephenylether ketone, polyetherketone ketone, and blends, co-polymers and alloys thereof and a second crosslinkable polymer selected from the group consisting of (i) polyphenylene sulfide; (ii) one or more of polysulfone, polyphenylsulfone, polyethersulfone, co-polymers and alloys thereof, and (iii) one or more of polyimide, thermoplastic polyimide, polyetherimide, and blends, co-polymers and alloys thereof.

12. The composition according to claim 6, wherein the composition comprising the at least one crosslinkable aromatic polymer further comprises at least one crosslinking compound that has a structure according to one of the following formulae: 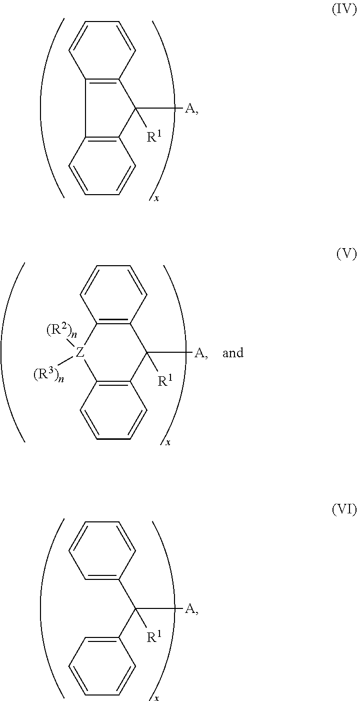
wherein A is a bond, an alkyl, an aryl, or an arene moiety having a molecular weight less than about 10,000 g/mol; wherein R¹, R², and R³ are the same or different and are independently selected from the group consisting of hydrogen, hydroxyl (—OH), amine (NH₂), halide, ester, ether, amide, aryl, arene, or a branched or straight chain, saturated or unsaturated alkyl group of one to about six carbon atoms; wherein m is from 0 to 2, n is from 0 to 2, and m+n is greater than or equal to zero and less than or equal to two; wherein Z is selected from the group of oxygen, sulfur, nitrogen, and a branched or straight chain, saturated or unsaturated alkyl group of one to about six carbon atoms; and wherein x is about 1 to about 6.

13. The composition according to claim 14, wherein the at least one crosslinking compound has a structure according to formula (IV) and is selected from the group consisting of

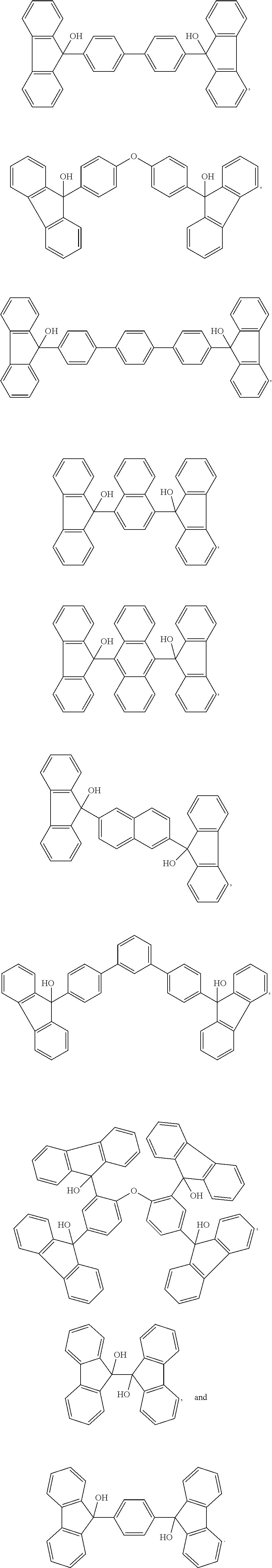

14. The composition according to claim 12, wherein the at least one crosslinking compound has a structure according to formula (V) and is selected from a group consisting of:

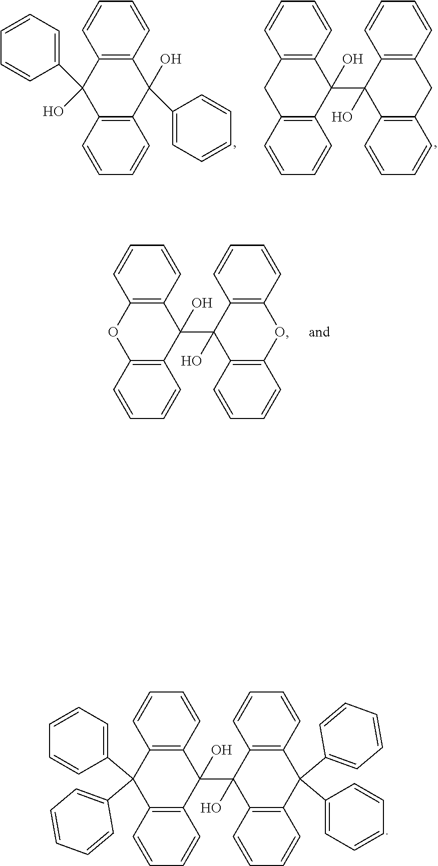

15. The composition according to claim 12, wherein the at least one crosslinking compound has a structure according to formula (VI) and is selected from the group consisting of:

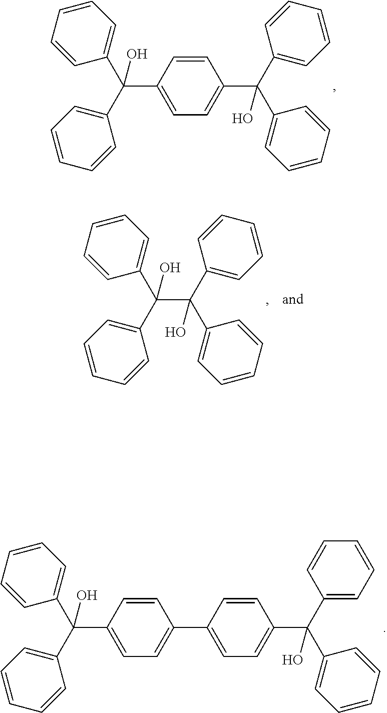 [SMILES: OC(c1ccccc1)(c1ccccc1)c1ccc(C(O)(c2ccccc2)c2ccccc2)cc1 ; OC(c1ccccc1)(c1ccccc1)C(O)(c1ccccc1)c1ccccc1 ; OC(c1ccccc1)(c1ccccc1)c1ccc(-c2ccc(C(O)(c3ccccc3)c3ccccc3)cc2)cc1]

16. The composition according to claim 12, wherein A has a molecular weight of about 1,000 g/mol to about 9,000 g/mol.

17. The composition according to claim 12, wherein the at least one crosslinking compound is present in the composition in an amount of about 1% by weight to about 50% by weight of an unfilled weight of the composition.

18. The composition according to claim 12, wherein a weight ratio of the aromatic polymer to the crosslinking compound in the composition is about 1:1 to about 100:1.

19. The composition according to claim 10, wherein the composition further comprises a crosslinking reaction control additive selected from a cure inhibitor or a cure accelerator.

20. The composition according to claim 19, wherein the crosslinking reaction control additive is present in the composition in an amount of about 0.01% to about 15% by weight of the crosslinking compound.

21. The composition according to claim 19, wherein the crosslinking reaction control additive is a cure inhibitor comprising lithium acetate.

22. The composition according to claim 19, wherein the crosslinking reaction control additive is a cure accelerator comprising magnesium chloride.

23. The composition according to claim 6, wherein the composition comprises one or more additives selected from continuous or discontinuous, long or short, reinforcing fibers selected from carbon fibers, glass fibers, woven glass fibers, woven carbon fibers, aramid fibers, boron fibers, polytetrafluoroethylene fibers, ceramic fibers, polyamide fibers; and/or one or more fillers selected from carbon black, silicate, fiberglass, glass beads, glass spheres, milled glass, calcium sulfate, boron, ceramic, polyamide, asbestos, fluorographite, aluminum hydroxide, barium sulfate, calcium carbonate, magnesium carbonate, silica, aluminum nitride, aluminum oxide, borax (sodium borax), activated carbon, pearlite, zinc terephthalate, graphite, graphene, talc, mica, silicon carbide whiskers or platelets, nanofillers, molybdenum disulfide, fluoropolymer fillers, boron nitride, nanodiamond, microdiamond, carbon nanotubes and fullerene tubes.

24. The composition according to claim 23, wherein the composition comprises about 0.5% by weight to about 65% by weight of the one or more additives and/or one or more fillers.

25. The composition according to claim 23, wherein the one or more additives is selected from carbon fiber, glass fiber, PTFE, and graphite.

26. An article formed from the composition according to claim 1.

27. The article according to claim 26, wherein the article subject to wear in use selected from rotary and reciprocating components selected from downhole tool components, an aerospace components, vehicle components, a semiconductor manufacturing component, and a tool having a rotating or reciprocating component.

28. The article according to claim 27, wherein the article is a gear, a rotor, a drill bit, a pulley, a bearing, and a seal.

29. A composition for use in forming an article subject to a frictional force or for use in a tribological system, comprising
at least one crosslinkable aromatic polymer matrix material; and
one or more additives selected from continuous or discontinuous, long or short, reinforcing fibers selected from carbon fibers, glass fibers, woven glass fibers, woven carbon fibers, aramid fibers, boron fibers, polytetrafluoroethylene fibers, ceramic fibers, polyamide fibers; and/or one or more fillers selected from carbon black, silicate, fiberglass, glass beads, glass spheres, milled glass, calcium sulfate, boron, ceramic, polyamide, asbestos, fluorographite, aluminum hydroxide, barium sulfate, calcium carbonate, magnesium carbonate, silica, aluminum nitride, aluminum oxide, borax (sodium borax), activated carbon, pearlite, zinc terephthalate, graphite, graphene, talc, mica, silicon carbide whiskers or platelets, nanofillers, molybdenum disulfide, fluoropolymer fillers, boron nitride, nanodiamond, microdiamond, carbon nanotubes and fullerene tubes.

30. The composition according to claim 29, wherein the composition comprises about 0.5% by weight to about 65% by weight of the one or more additives and/or one or more fillers.

31. The composition according to claim 29, wherein the one or more additives is selected from carbon fiber, glass fiber, PTFE, and graphite.

32. The composition according to claim 29, wherein the at least one crosslinkable aromatic polymer matrix material is a crosslinkable polymer selected from polyarylenes, polysulfones, polyethersulfones, polyphenylene sulfides, polyphenylene oxides, polyimides, polyetherimides, thermoplastic polyimides, polybenzamide, polyamide-imide, polyurea, polyurethane, polyphthalamide, polybenzimidazole, polyaramid, and blends, co-polymers, and alloys thereof.

33. The composition according to claim 32, wherein the at least one crosslinkable aromatic polymer is a crosslinkable polyarylene selected from polyetherketone, polyetheretherketone, polyetherdiphenylether ketone, polyetherketone ketone, and blends, co-polymers and alloys thereof.

34. The composition according to claim 33, wherein the at least one crosslinkable aromatic polymer comprises one or more functionalized groups for crosslinking.

35. The composition according to claim 33, wherein the at least one crosslinkable polymer is a polyarylene ether having repeating units along its backbone according to the structure of formula (I): 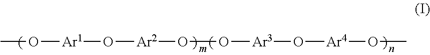
wherein Ar¹, Ar², Ar³ and Ar⁴ are identical or different aryl radicals, m=0 to 1, and n=1-m.

36. The composition according to claim 35, wherein the at least one crosslinkable aromatic polymer has repeating units along its backbone having the structure of formula (II): 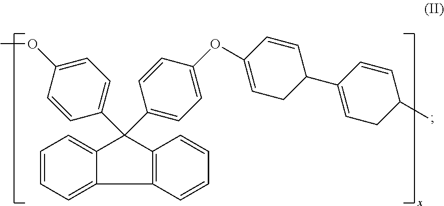
formula (IIa):

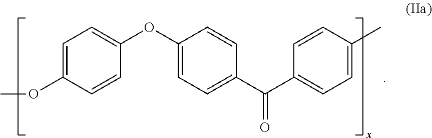

37. The composition according to claim 29, wherein the at least one crosslinkable polymer comprises a first crosslinkable polymer that is one or more polyarylene selected from polyetherketone, polyetheretherketone, polyetherdiephenylether ketone, polyetherketone ketone, and blends, co-polymers and alloys thereof and a second crosslinkable polymer selected from the group consisting of (i) polyphenylene sulfide; (ii) one or more of polysulfone, polyphenylsulfone, polyethersulfone, co-polymers and alloys thereof, and (iii) one or more of polyimide, thermoplastic polyimide, polyetherimide, and blends, co-polymers and alloys thereof.

38. The composition according to claim 29, wherein the composition comprising the at least one crosslinkable aromatic polymer further comprises at least one crosslinking compound that has a structure according to one of the following formulae: 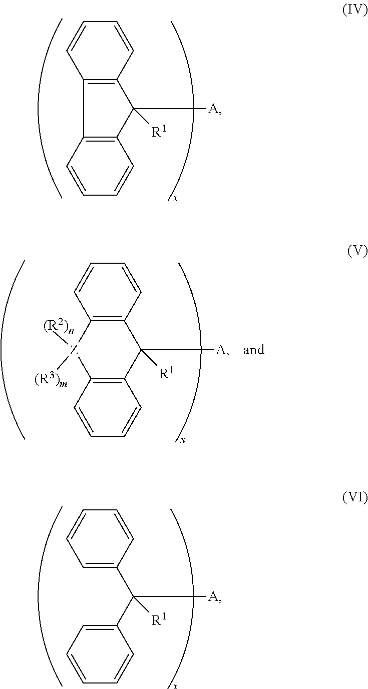
wherein A is a bond, an alkyl, an aryl, or an arene moiety having a molecular weight less than about 10,000 g/mol; wherein R¹, R², and R³ are the same or different and are independently selected from the group consisting of hydrogen, hydroxyl (—OH), amine (NH₂), halide, ester, ether, amide, aryl, arene, or a branched or straight chain, saturated or unsaturated alkyl group of one to about six carbon atoms; wherein m is from 0 to 2, n is from 0 to 2, and m+n is greater than or equal to zero and less than or equal to two; wherein Z is selected from the group of oxygen, sulfur, nitrogen, and a branched or straight chain, saturated or unsaturated alkyl group of one to about six carbon atoms; and wherein x is about 1 to about 6.

39. A method of improving the wear resistance of an article formed from a composition, wherein the article is for use in a high PV end application in which it is subject to a frictional force or used in a tribological system, comprising
providing to the composition at least one crosslinkable aromatic polymer matrix material which, when crosslinked, remains operable at a PV of at least about 75,000 psi-ft./min;
crosslinking the at least one crosslinkable aromatic polymer in the composition; and
forming the article.

40. The method according to claim 39, wherein the at least one crosslinkable aromatic polymer matrix material, when crosslinked remains operable at a PV of about 75,000 psi-ft./min to about 100,100 psi-ft./min.

41. The method according to claim 39, wherein the at least one crosslinkable aromatic polymer matrix material has a PV limit measured in psi-ft./min. at about 500° F. that is at least about 10% higher than a PV limit measured in psi-ft./min at about 500° F. of an uncrosslinkable version of the same aromatic polymer matrix material

42. The method according to claim 41, wherein the PV limit when crosslinked, measured in psi-ft./min. at about 500° F. is at least about 20% higher than a PV limit of an uncrosslinkable version of the same aromatic polymer matrix material.

43. The method according to claim 42, wherein the PV limit when crosslinked, measured in psi-ft./min. at about 500° F. is at least about 50% higher than a PV limit of an uncrosslinkable version of the same aromatic polymer matrix material.

44. The method according to claim 39, further comprising providing to the composition one or more additives selected from carbon fiber, glass fiber, PTFE, and graphite.

45.-81. (canceled)

82. A composition for use in forming an article subject to a frictional force or for use in a tribological system, comprising
at least one crosslinkable aromatic polymer matrix material wherein,
(i) when crosslinked, substantially maintains its dimensional stability after heating above a critical transition temperature;
(ii) when crosslinked, it avoids catastrophic failure above the critical transition temperature; and/or
(iii) when crosslinked and incorporated into an article subject to a frictional force or in a tribological system, substantially retains its dimensional stability over the critical transition temperature of the crosslinked aromatic polymer in the article.

83. The composition according to claim 82, wherein the critical transition temperature is a glass transition temperature or a melting point temperature.

84. (canceled)

85. A method of retaining dimensional stability and/or avoiding catastrophic failure above a critical transition temperature of an article subject to a frictional force and/or used in a tribological system, comprising
forming the article from the composition according to claim 82; and
incorporating the article in an application subject to a frictional force and/or used in a tribological system, wherein the temperature of the article in the application exceeds a critical transition temperature of the aromatic polymer in the article.

86. The method according to claim 85, wherein the crosslinked aromatic polymer is a matrix material in the article.

87. (canceled)

88. The method according to claim 85, wherein the critical transition temperature is a glass transition temperature or a melting temperature.

89. (canceled)
